(19) United States
(12) Patent Application Publication
(10) Pub. No.: US 2026/0320554 A1
(43) Pub. Date: Oct. 15, 2026

(54) METHODS AND SYSTEMS FOR CONSTRAINT-BASED SELECTION OF DISCRETE UNITS FROM EXTERNAL DATA SYSTEMS

(71) Applicant: Eat Cook Joy Inc, San Francisco, CA (US)

(72) Inventors: Zainab Gulamabbas Ghadiyali, San Francisco, CA (US); Sindhu Satish, San Jose, CA (US)

(21) Appl. No.: 19/642,555

(22) Filed: Apr. 8, 2026

Related U.S. Application Data
(60) Provisional application No. 63/785,920, filed on Apr. 9, 2025.

(51) Int. Cl. G06Q 10/087

(52) U.S. Cl. CPC G06Q 10/08772

(57) ABSTRACT

Methods and systems for constraint-based selection of discrete units from external data systems. Data associated with ingredients of a cooking recipe is obtained. Candidate product records are retrieved from external systems. Each candidate product record corresponds to a product available from the external systems and specifies a unit quantity of a respective ingredient provided by a unit of the product and at least one attribute associated with the product. One or more candidate product records are identified based on the at least one attribute and constraints including a quantity constraint in which unit quantities specified by the candidate product records satisfy a quantity associated with the ingredients, and a unit-based constraint corresponding to fixed unit quantities of the products. A machine-readable data structure identifying the one or more candidate product records is generated and caused to be stored and made accessible to at least one client device.

### RELATED APPLICATIONS

This application claims the benefit of U.S. Provisional Patent Application No. 63/785,920 filed Apr. 9, 2025, the contents of which is incorporated by reference in its entirety herein.

### TECHNICAL FIELD

Aspects and implementations of the present disclosure relate to methods and systems for constraint-based selection of discrete units from external systems.

### BACKGROUND

Computing systems have increasingly been employed to process and transform recipe-related data to support meal planning and ingredient acquisition workflows. Conventional approaches typically involve users manually interpreting recipe content, extracting ingredient information, and identifying corresponding items across one or more external data sources. Some existing systems generate ingredient lists from recipe content, however, such systems often operate on unstructured or inconsistently formatted data and provide outputs that require further manual interpretation or processing. In particular, conventional systems may not adequately address differences between ingredient quantities specified in recipe content and quantities associated with available items represented in external data sources. For example, recipe content may specify ingredient quantities in variable units, while external systems represent corresponding items using fixed unit quantities. Existing approaches also may not effectively account for variability in item representations across multiple external systems, including differences in packaging, availability, or associated characteristics. Additionally, recipe content may be provided in diverse formats, including web-based content, media content, or free-form text, which can present challenges for consistent data extraction and representation.

### SUMMARY

The summary below is a simplified summary of the disclosure in order to provide a basic understanding of some aspects of the disclosure. This summary is not an extensive overview of the disclosure. It is intended neither to identify key or critical elements of the disclosure, nor to delineate any scope of the particular implementations of the disclosure or any scope of the claims. Its sole purpose is to present some concepts of the disclosure in a simplified form as a prelude to the more detailed description that is presented later.

According to an aspect of the present disclosure, a method is provided. The method includes obtaining, by a computing system, data associated with ingredients of a cooking recipe. The method includes retrieving, from one or more external systems, candidate product records. Each candidate product record of the candidate product records corresponds to a product available from the one or more external systems and specifies a unit quantity of a respective ingredient of the ingredients provided by a unit of the product, and at least one attribute associated with the product. The method includes identifying, among the candidate product records, one or more candidate product records based on one or more constraints including a quantity constraint in which unit quantities specified by the one or more candidate product records satisfy a quantity associated with the ingredients, and a unit-based constraint corresponding to fixed unit quantities of the products. The method includes generating a machine-readable data structure identifying the one or more candidate product records. The method includes causing the machine-readable data structure to be stored and made accessible to at least one client device.

According to other aspects of the present disclosure, the method may include one or more of the following features. Identifying the one or more candidate product records may include providing at least the candidate product records and the one or more constraints as an input to an optimization function, obtaining one or more outputs of the optimization function, the one or more outputs indicating quantities of units of the products associated with the candidate product records based on the at least one attribute and the one or more constraints, and selecting the one or more candidate product records corresponding to the quantities of units specified by the one or more outputs of the optimization function.

In some implementations, the unit-based constraint may restrict quantities of units of the products to non-fractional values.

In some implementations, the method may further include obtaining recipe content associated with the cooking recipe, the recipe content including at least one of image data, video data, or text data associated with the cooking recipe, and generating a unified representation of the recipe content.

In some implementations, the method may further include generating, from the unified representation using an artificial intelligence model, a structured recipe object including an indication of the ingredients and an amount of each of the ingredients, and transforming the ingredients indicated by the structured recipe object into a set of normalized ingredient representations by performing one or more of an ingredient amount conversion operation to convert the amount of each of the ingredients into a common unit of measure, an ingredient name resolution operation to resolve identifiers associated with each of the ingredients with a standard ingredient identifier, or a unit quantity standardization operation to generate, for each of the ingredients, a unit quantity expressed in the common unit of measure. The candidate product records may be retrieved based on the set of normalized ingredient representations.

In some implementations, transforming the ingredients may further include determining, for at least one ingredient of the ingredients, a yield factor corresponding to a preparation loss associated with the at least one ingredient, and adjusting a quantity associated with the at least one ingredient based on the yield factor.

In some implementations, obtaining the recipe content may include detecting an input type associated with the recipe content based on at least one of a uniform resource locator pattern, a multipurpose internet mail extension pattern or a uniform resource identifier prefix, and routing the recipe content through a processing path corresponding to the detected input type.

In some implementations, the method may further include determining, for at least one ingredient of the ingredients, an inventory quantity corresponding to an on-hand quantity of the at least one ingredient available in an inventory, and modifying the quantity constraint to account for the inventory quantity.

In some implementations, determining the inventory quantity may include querying an inventory data store including one or more entries, each entry corresponding to a respective on-hand ingredient available in the inventory, based on the querying, identifying one or more on-hand ingredients having an expiration time within a threshold of a current time, and updating the inventory quantity based on the on-hand quantity of the identified one or more on-hand ingredients.

In some implementations, the method may further include receiving a request to substitute at least one ingredient of the ingredients, and responsive to the request, identifying one or more substitute ingredients for the at least one ingredient of the ingredients based on a substitution data structure including mappings between ingredients and substitute ingredients. One or more candidate product records of the candidate product records may correspond to the one or more substitute ingredients.

In some implementations, the method may further include receiving, from the at least one client device, an approval indication associated with the machine-readable data structure, grouping the one or more candidate product records based on corresponding retail entities, transmitting, to a computing system associated with each corresponding retail entity, order data corresponding to the grouped candidate product records to cause placement of an order for units of the products associated with the grouped candidate product records, and responsive to placement of the order, generating one or more inventory update records for products having unit quantities that exceed quantities associated with corresponding ingredients of the ingredients.

In some implementations, the at least one attribute may include one or more of a product weight attribute, a product availability indicator, a delivery characteristic, a quality indicator, or a cost indicator associated with the product.

In some implementations, the method may further include generating one or more alternative machine-readable data structures by identifying alternative candidate product records of the candidate product records subject to at least one or more additional constraints. The one or more additional constraints may include at least one of a single-retail entity constraint limiting selection of candidate product records to products available from a single retail entity, or a product preference constraints prioritizing candidate product records having a specified attribute value. The method may further include causing the one or more alternative machine-readable data structures to be presented to the at least one client device for selection by a user.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example system architecture, in accordance with implementations of the present disclosure.

FIG. 2 illustrates a block diagram illustrating an example unit constraint engine, in accordance with implementations of the present disclosure.

FIG. 3 is a flow diagram of an example method for constraint-based selection of discrete units from external systems, in accordance with implementations of the present disclosure.

FIG. 4 illustrates an example of constraint-based selection of discrete units from external systems, in accordance with implementations of the present disclosure.

FIG. 5 illustrates an example user interface (UI), in accordance with implementations of the present disclosure.

FIG. 6 illustrates an example predictive system, in accordance with implementations of the present disclosure.

FIG. 7 is a flow diagram of an example method for generating execution timing information for cooking service sessions, in accordance with implementations of the present disclosure.

FIG. 8 is a flow diagram of an example method for tool-driven conversational recipe search using artificial intelligence (AI), in accordance with implementations of the present disclosure.

FIG. 9 is a flow diagram of an example method for AI-based recipe metadata generation and database, in accordance with implementations of the present disclosure.

FIG. 10 is a flow diagram of an example method for generating an image representing food of a cooking recipe using an AI model, in accordance with implementations of the present disclosure.

FIG. 11 is a block diagram illustrating an exemplary computer system, in accordance with implementations of the present disclosure.

### DETAILED DESCRIPTION OF THE DRAWINGS

Computing systems have become integral to modern culinary workflows, spanning applications from household meal planning to commercial food service operations. At the intersection of artificial intelligence, data integration, and structured data processing, systems designed to assist with recipe-based tasks draw upon multiple technical disciplines. Recipe content exists across a heterogeneous landscape of digital formats, including structured web pages with embedded metadata, unstructured social media posts, photographic captures of printed cookbooks, and free-form textual descriptions shared through messaging platforms. The translation of such diverse content into actionable data suitable for downstream processing represents a foundational challenge in computing systems for processing recipe data. Beyond content extraction, the mapping of recipe ingredients to items represented in external data systems involves interfacing with external data systems that maintain their own data schemas, inventory states, and item representations. These external systems expose product catalogs through application programming interfaces or web-based interfaces, each presenting items as discrete, indivisible units with fixed quantities rather than continuously divisible commodities.

Conventional approaches to recipe-based ingredient-to-item mapping exhibit several shortcomings that limit their practical utility. Traditional systems typically generate simple ingredient lists from recipe content without accounting for the fundamental mismatch between recipe-specified quantities and unit quantities represented in external systems. For instance, a recipe calling for two hundred grams of flour cannot be directly satisfied by selecting exactly two hundred grams when retail offerings consist of one-kilogram bags. Existing solutions often delegate this reconciliation to end users, who must manually calculate how many packages to purchase and track resulting surplus quantities. Furthermore, conventional systems frequently operate in isolation from user inventory data, resulting in redundant purchases of ingredients already available in home or commercial kitchens. The heterogeneity of recipe content formats poses additional challenges, as many existing systems support only specific input types and fail to provide unified processing pipelines capable of handling images, videos, and text with equal facility. Additionally, existing systems often fail to integrate data across multiple external systems, with most conventional approaches limiting product selection to a single retail source rather than aggregating offerings across multiple external systems to identify optimal purchasing configurations.

The technical and operational consequences of these conventional limitations manifest across multiple dimensions. Users experience degraded efficiency when forced to perform manual calculations and cross-reference multiple retail platforms independently. Computational resources are underutilized when systems fail to leverage structured processing techniques capable of selecting combinations of discrete units represented in external systems under defined constraints. Inventory waste increases when systems cannot account for on-hand quantities or track surplus ingredients resulting from package-size mismatches, leading to food spoilage and economic loss. The inability to process diverse recipe content formats creates friction in user workflows, as individuals must manually transcribe or reformat recipe information before system ingestion. From a data integration perspective, conventional approaches often fail to normalize ingredient representations across different measurement systems, naming conventions, and preparation states, resulting in inconsistent matching between recipe ingredients and retail product catalogs. These inefficiencies compound in commercial food service contexts, where procurement decisions affect operational costs, inventory management complexity, and service delivery timelines.

Embodiments of the present disclosure provide techniques for processing structured recipe data and selecting discrete unit-based representations from external data systems under constraints. In accordance with implementations, a computing system obtains data associated with ingredients of a cooking recipe. The system may obtain recipe content associated with the cooking recipe in various forms including image data, video data, or text data. The system may detect input types based on uniform resource locator patterns, multipurpose internet mail extension patterns, or uniform resource identifier prefixes. The system may route content through processing paths corresponding to detected input types to generate a unified representation of the recipe content. The system may use an artificial intelligence (AI) model to process this unified representation to generate a structured recipe object containing indications of ingredients and amounts. Transformation operations convert this structured object into normalized ingredient representations through ingredient amount conversion to common units of measure, ingredient name resolution to standard identifiers, and unit quantity standardization. For ingredients subject to preparation losses, the system determines yield factors and adjusts quantities accordingly, to account for preparation-related losses.

The computing system retrieves, from one or more external systems, candidate product records that each correspond to a product available from the one or more external systems and specifies a unit quantity of a respective ingredient provided by a unit of the product, and at least one attribute associated with the product. Product attributes considered during retrieval and subsequent processing may include a product weight attribute, a product availability indicator, a delivery characteristic, a quality indicator, or a cost indicator associated with the product. The system may interface with an inventory data store associated with an inventory and determine on-hand quantities of ingredients. Inventory entries approaching expiration may be prioritized for use, with the system identifying on-hand ingredients having expiration times within a threshold of the current time. Ingredient substitution capabilities allow users to request replacements for specific ingredients, with the system consulting substitution data structures containing mappings between ingredients and substitute ingredients to identify substitute ingredients corresponding to at least one ingredient. In some implementations, the candidate product records reflect current states of the external systems, including real-time availability, unit-based representations, and associated attributes.

The computing system identifies, among the candidate product records, one or more candidate product records based on one or more constraints. The constraints may include a quantity constraint in which unit quantities specified by the one or more candidate product records satisfy quantities associated with the ingredients, and/or a unit-based constraint corresponding to fixed unit quantities of the products. The unit-based constraint restricts quantities of units of the products to non-fractional values, reflecting the discrete nature of unit-based representations in the external systems. The identification may involve providing at least the candidate product records and the one or more constraints as an input to an optimization function, obtaining one or more outputs of the optimization function indicating quantities of units of the products based on the at least one attribute and the one or more constraints, and selecting the one or more candidate product records corresponding to the quantities of units specified by the outputs. The system may modify the quantity constraint to account for inventory quantities corresponding to on-hand quantities of ingredients available in an inventory, in some embodiments.

The computing system generates a machine-readable data structure identifying the one or more candidate product records. The machine-readable data structure may encode the selected products, their quantities, associated retail entities, attribute information, and/or mappings to corresponding recipe ingredients. For example, the machine-readable data structure may specify that two units of a one-kilogram flour package from a first retail entity and one unit of a 500-gram butter package from a second retail entity satisfy the flour and butter requirements of the cooking recipe, along with attribute indicators and availability information for each selected product. In some embodiments, the system may generate one or more alternative machine-readable data structures by identifying alternative candidate product records of the candidate product records subject to one or more additional constraints. These additional constraints may include a single-retail entity constraint limiting selection of candidate product records to products available from a single retail entity, simplifying fulfillment logistics, and/or product preference constraints prioritizing candidate product records having a specified attribute value such as organic certification or brand preferences. The computing system causes the machine-readable data structure to be stored and made accessible to at least one client device. Multiple alternative configurations may be presented to client devices for user selection, enabling informed decision-making based on cost, convenience, or quality considerations. Upon receiving an approval indication from the at least one client device associated with the machine-readable data structure, the system groups the one or more candidate product records based on corresponding retail entities and transmits, to a computing system associated with each corresponding retail entity, order data corresponding to the grouped candidate product records to cause placement of an order for units of the products. Responsive to placement of the order, the system generates one or more inventory update records for products having unit quantities that exceed quantities associated with corresponding ingredients, reflecting surplus quantities available for future use.

Implementations of the present disclosure address the above and other deficiencies of conventional systems by providing computing techniques for transforming heterogeneous recipe data into structured representations and selecting discrete unit-based item representations from external data systems under constraints that respect the discrete unit nature of unit-based representations in external systems. In particular, the disclosed techniques process candidate product records obtained from external systems and enforce constraints based on unit quantities and ingredient representations, enabling selection of combinations of records that satisfy defined relationships between ingredient quantities and unit quantities. The evaluation of combinations of unit-based representations across multiple external systems under defined constraints involves processing structured data at a scale that is not practically performed manually. The computing system generates and operates on structured data representations that encode relationships between ingredient quantities and unit-based representations of items in external systems. The constraints define permissible selections of unit-based representations and govern operation of the computing system in generating machine-readable outputs. The generated machine-readable data structures are configured for use in subsequent system-level operations involving external systems and inventory data, rather than merely presenting information for user evaluation.

The integration of inventory data introduces additional constraints based on on-hand quantities and expiration information, allowing the computing system to modify constraint conditions dynamically based on system state. The disclosed systems further transform diverse recipe content formats into unified structured representations using processing pipelines that support multiple input types, including image, video, and text data. By retrieving data from multiple external systems and processing discrete unit-based representations, the computing system performs selection across heterogeneous data sources while respecting constraints associated with unit quantities and item availability. The use of discrete unit constraints further ensures that selected representations correspond to non-fractional unit quantities, reflecting limitations of unit-based representations in external systems and preventing generation of infeasible selections. These techniques provide improvements in computing system operation by enabling structured processing of heterogeneous data, enforcing constraints associated with unit-based representations, and generating machine-readable data structures that are usable for subsequent system-level operations involving external systems and inventory data.

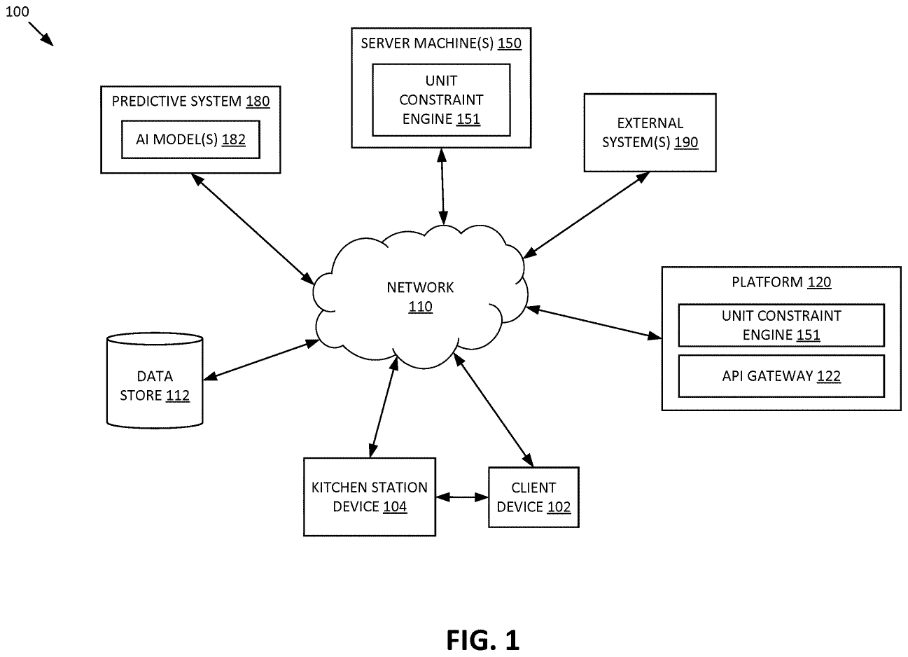

FIG. 1 illustrates an example system architecture 100, in accordance with implementations of the present disclosure. The system architecture 100 (also referred to as “system” herein) includes a client device 102, a kitchen station device 104, a data store 112, a platform 120, a server machine 150, a predictive system 180, and/or one or more external systems 190 each connected to a network 110. In implementations, network 110 can include a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof.

In some implementations, data store 112 is a persistent storage that is capable of storing data as well as data structures to tag, organize, and index the data. In some embodiments, data store 112 can store metadata, recipe content, inventory data, candidate product records, and other information utilized by the system architecture 100. Data store 112 can be hosted by one or more storage devices, such as main memory, magnetic or optical storage based disks, tapes or hard drives, NAS, SAN, and so forth. In some implementations, data store 112 can be a network-attached file server, while in other embodiments data store 112 can be some other type of persistent storage such as an object-oriented database, a relational database, and so forth, that may be hosted by platform 120 or one or more different machines coupled to the platform 120 via network 110.

The client device 102 can include computing devices such as personal computers (PCs), laptops, mobile phones, smart phones, tablet computers, netbook computers, network-connected televisions, etc. In some implementations, client device 102 may also be referred to as a “user device.” The client device 102 includes one or more processors, memory, a display device, and a network interface for communicating with the platform 120 and other components of the system architecture 100 via the network 110. The client device 102 may execute a client application or web browser that renders a user interface (UI) for presenting information to a user and receiving user input. The UI may display recipe content, on-hand ingredients with associated expiration information, shopping cart contents including selected products and corresponding prices, and action controls such as approval and decline buttons for confirming or rejecting proposed product selections. The UI may further include controls for requesting ingredient substitutions, viewing alternative shopping cart configurations, and editing cart contents. The client device 102 transmits user input, including approval indications and substitution requests, to the platform 120 and receives machine-readable data structures identifying selected candidate product records for presentation to the user.

The kitchen station device 104 provides an interface for culinary service operations and communicates with other components of the system architecture 100 through the network 110. The kitchen station device 104 provides an interface for culinary service operations and communicates with other components of the system architecture 100 through the network 110. In some implementations, the kitchen station device 104 may include a computing device positioned within a kitchen environment, such as a tablet computer, a dedicated terminal, or a display-equipped appliance. The kitchen station device 104 may be deployed in various kitchen environments, including home kitchens, commercial kitchens, or other food preparation facilities. In home kitchen implementations, the kitchen station device 104 may include a personal tablet, smartphone, or smart display positioned in the cooking area to provide recipe guidance, ingredient management, and timing assistance to home cooks. The kitchen station device 104 includes one or more processors, memory, a display device, input mechanisms (such as a touchscreen interface or physical controls), and a network interface for communicating with the platform 120, data store 112, and other components of the system architecture 100 via the network 110. In commercial kitchen environments, the kitchen station device 104 may be associated with a specific preparation station, such as a prep station, hot line, cold line, or other designated work area. The kitchen station device 104 may execute applications that render user interfaces for displaying recipe instructions, ingredient lists, timing information for cooking tasks, and inventory status associated with the kitchen environment. In some embodiments, the kitchen station device 104 may receive and display execution timing information generated by the predictive system 180, including estimated durations for cooking tasks and service sessions. The kitchen station device 104 may further interface with inventory management functionality, enabling kitchen personnel or home users to record ingredient usage, log waste, update on-hand quantities, and receive alerts regarding ingredients approaching expiration. In implementations involving multiple kitchen station devices 104, each device may be associated with a respective station identifier, enabling the platform 120 to route station-specific information and coordinate workflows across the kitchen environment.

In some embodiments, client device 102 and kitchen station device 104 can access content associated with platform 120 via an application programming interface (API) gateway 122. The API gateway 122 exposes secure, standardized endpoints that external systems can interact with over the network 110, allowing client applications to send requests to perform tasks such as retrieving data or updating settings. The API gateway 122 may implement representational state transfer (REST) or graph query language (GraphQL) conventions, enabling client applications including mobile applications, web applications, and backend services to transmit hypertext transfer protocol (HTTP) requests for performing operations such as creating user accounts, retrieving recipe content, updating inventory data, or initiating constraint-based selection of candidate product records. Each request transmitted to the API gateway 122 may include authentication credentials, such as API keys or open authorization (OAuth) tokens, which the platform 120 uses to verify identity and permissions associated with the requesting client device or application. Upon receiving a request, the API gateway 122 routes the request to appropriate components of the platform 120 for processing, which may involve executing business logic, interacting with the data store 112 or other services, and generating a structured response in a format such as JavaScript Object notation (JSON). The API gateway 122 may further support webhook functionality, enabling the platform 120 to transmit real-time updates to client applications when specified events occur, such as completion of order placement, updates to inventory quantities, or changes in product availability from external systems 190. In some implementations, the API gateway 122 implements rate limiting to control the frequency of requests from client devices, caching mechanisms to reduce latency for frequently accessed data, and logging functionality to record request and response data for monitoring and debugging purposes. The API gateway 122 may also perform request validation, ensuring that incoming requests conform to expected schemas before routing to downstream services, and may implement circuit breaker patterns to gracefully handle failures in communication with external systems 190 or other components of the system architecture 100.

In some embodiments, platform 120 can be a Software as a Service (SaaS) platform. A SaaS platform refers to a cloud-based software model that provides users with access to applications over the internet, typically via a subscription. Instead of installing and maintaining software on individual computers or servers, users simply log in through a web browser. The platform provider handles maintenance, updates, security, and infrastructure. The SaaS architecture enables the platform 120 to provide centralized processing of recipe content, constraint-based selection of candidate product records, and coordination with external systems 190 without requiring installation of specialized software on client devices 102 or kitchen station devices 104. In some implementations, the platform 120 may operate in a multi-tenant configuration, wherein computing resources, data storage, and processing capabilities are shared across multiple users or organizations while maintaining logical separation of user data and configurations. The multi-tenant architecture enables efficient utilization of computing resources and facilitates deployment of updates and enhancements to all users simultaneously. The platform 120 may implement horizontal scaling capabilities to accommodate varying workloads, such as increased demand during peak meal planning periods or high-volume order processing times. In some embodiments, the platform 120 may be deployed across multiple geographic regions or availability zones to provide redundancy, reduce latency for geographically distributed users, and ensure continued operation in the event of localized infrastructure failures. The platform 120 may further implement data isolation mechanisms to ensure that recipe content, inventory data, and candidate product record selections associated with one user or organization are not accessible to other users or organizations sharing the same platform infrastructure.

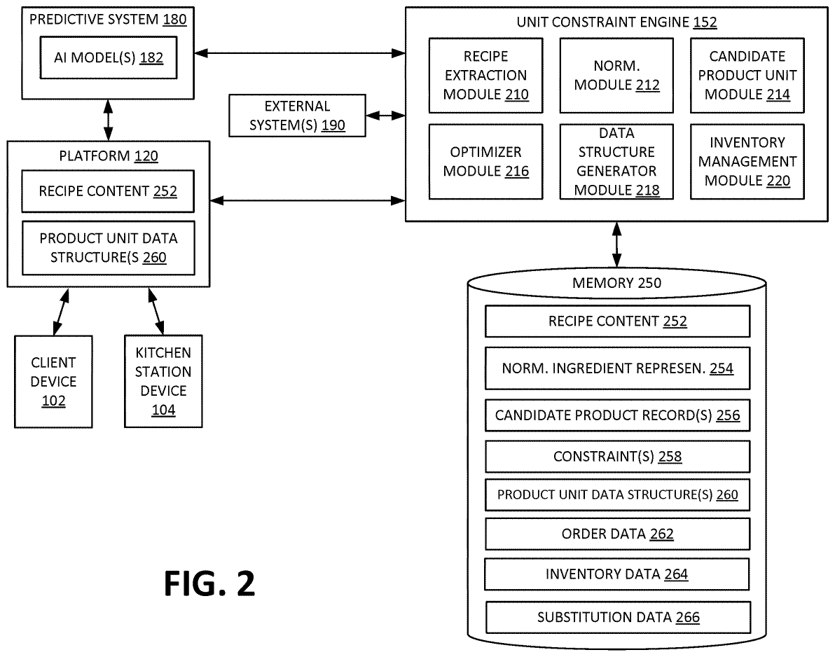

As illustrated in FIG. 1, platform 120 and/or server machine 150 may include a unit constraint engine 151. The unit constraint engine 151 performs operations pertaining to constraint-based selection of discrete units from external data systems. In particular, the unit constraint engine 151 obtains data associated with ingredients of a cooking recipe, retrieves candidate product records from one or more external systems 190, identifies one or more candidate product records based on constraints including a quantity constraint and a unit-based constraint corresponding to fixed unit quantities of products, generates a machine-readable data structure identifying the selected candidate product records, and causes the machine-readable data structure to be stored and made accessible to at least one client device. The unit-based constraint restricts quantities of units of the products to non-fractional values, reflecting the discrete nature of unit-based representations in the external systems 190. Further details regarding unit constraint engine 151 are provided below with respect to FIGS. 2-5.

The predictive system 180 includes one or more AI models 182. The AI models 182 may be used to generate structured recipe objects from unified representations of recipe content, including processing image data, video data, or text data associated with cooking recipes. The predictive system 180 can generate training data to be used to train the AI models 182. In some embodiments, the predictive system 180 can generate the training data based on historical cooking session data including historical tasks and historical resource constraints stored at data store 112 or another data store connected to system architecture 100 via network 110.

In some embodiments, the AI models 182 may include one or more fine-tuned language models configured to perform specific tasks associated with culinary service operations. For example, a first AI model of the AI models 182 may be trained to extract structured recipe data from unstructured or semi-structured content, including web pages, social media posts, video transcripts, and images of cookbook pages. The first AI model may receive a unified representation of recipe content and generate a structured recipe object containing fields such as recipe title, description, serving count, preparation time, cooking time, a categorized list of ingredients with amounts and units, and step-by-step cooking instructions. A second AI model of the AI models 182 may be trained to estimate session durations for cooking service sessions based on dish complexity, number of dishes, and nature of dishes in a planned menu. The second AI model may process natural-language instructions associated with each dish and generate both an estimated total session time and an explanation justifying the estimate. A third AI model of the AI models 182 may be trained to predict grocery costs from ingredient-level dish data, learning to infer costs based on complexity, quantity, and variety of ingredients across dishes.

The predictive system 180 may employ multi-turn conversational training techniques for the AI models 182. In such implementations, training data may be formatted into chat-style prompts including system messages, user messages, and assistant responses. For session duration estimation, the training data may simulate a multi-turn conversation where the AI model proposes an initial estimate, then is prompted to revise its explanation to match ground truth data derived from actual recorded durations of historical cooking sessions. This training approach enables the AI model to not only predict numerical values but also to generate reasoning that justifies the predictions, improving transparency and user trust in the system outputs.

The AI models 182 may further include models configured for tool-driven conversational interactions. In such implementations, an AI model may be provided with a set of callable tools and may autonomously decide which tools to invoke, in what order, and with what parameters. For recipe search operations, the AI model may interpret user intent from natural language queries, select relevant tools such as structured query language (SQL) query generators or semantic search functions, construct database queries based on interpreted filters, and return recipe recommendations that satisfy user-specified requirements. The AI model may implement a delay mechanism that prevents finalization of results until reasoning through search and logic operations is complete, ensuring that outputs reflect comprehensive evaluation of available options.

The predictive system 180 may generate metadata for recipe records using the AI models 182. In such implementations, an AI model may receive unstructured or semi-structured recipe data and generate standardized metadata across defined taxonomies. The generated metadata may include dish type classifications (e.g., appetizer, main course, dessert), flavor profile indicators (e.g., savory, spicy, sweet), meat type identifiers, cooking method classifications, time of day suitability indicators, preparation and cooking time estimates, protein content values, main ingredient identifications, and nutritional tags (e.g., low-fat, high-protein, gluten-free). The generated metadata enables indexing of recipe records according to a standardized protocol, facilitating subsequent retrieval and recommendation operations by the AI models 182 or other system components.

The predictive system 180 may further generate image prompts for visual content generation using the AI models 182. In such implementations, an AI model may receive structured recipe data and generate natural-language prompts suitable for food photography or generative image models. The generated prompts may specify styling characteristics, camera settings, lighting conditions, backdrop materials, and garnish elements appropriate for the particular dish. In some embodiments, the AI model may intelligently identify camera settings for AI-generated images based on characteristics of the food and scene to be depicted, with different settings selected for different food types and environmental contexts.

The external system 190 represents one or more retail platforms or other external data systems from which candidate product records are retrieved. External systems 190 may include grocery retailers, wholesale distributors, specialty food suppliers, or other commercial entities that maintain product catalogs accessible via application programming interfaces or web-based interfaces. Each external system 190 maintains its own data schemas, inventory states, pricing structures, and item representations. Products available from external systems 190 are represented as discrete, indivisible units with fixed quantities rather than continuously divisible commodities. For example, an external system 190 associated with a grocery retailer may expose a product catalog containing items such as one-kilogram bags of flour, 500-gram packages of butter, or individual units of produce, each with associated attributes including product weight, availability indicators, delivery characteristics, quality indicators, and cost indicators. The unit constraint engine 151 interfaces with external systems 190 to retrieve candidate product records that specify unit quantities of ingredients provided by units of products, enabling the constraint-based selection process to identify combinations of discrete units that satisfy recipe ingredient requirements.

It should be noted that although FIG. 1 illustrates the unit constraint engine 151 as part of both platform 120 and server machine 150, in additional or alternative embodiments, the unit constraint engine 151 can reside on one or more server machines that are remote from platform 120. It should be noted that in some other implementations, the functions of server machine 150, platform 120, and/or predictive system 180 can be provided by a fewer number of machines. For example, in some implementations, components and/or modules of server machine 150 may be integrated into a single machine, while in other implementations components and/or modules of server machine 150 may be integrated into multiple machines. In addition, in some implementations, components and/or modules of server machine 150 may be integrated into platform 120.

In general, functions described in implementations as being performed by platform 120 and/or server machine 150 can also be performed on the client device 102 or kitchen station device 104 in other implementations. In addition, the functionality attributed to a particular component can be performed by different or multiple components operating together. Platform 120 can also be accessed as a service provided to other systems or devices through appropriate application programming interfaces, and thus is not limited to use in websites.

In implementations of the present disclosure, user data collection and processing operations are performed with user consent. Prior to collecting, storing, or processing user data such as recipe preferences, inventory information, purchase history, or usage patterns, the system obtains explicit consent from the user through appropriate consent mechanisms presented via the client device 102 or kitchen station device 104. Users may be presented with consent interfaces that describe the types of data to be collected, the purposes for which the data will be used, and the duration for which the data will be retained. Users may grant or withhold consent for specific categories of data collection, and may modify or revoke previously granted consent through user account settings or privacy controls accessible via the platform 120. The system maintains records of user consent status and ensures that data collection and processing operations are performed only for users who have provided the requisite consent. In some embodiments, the system may implement granular consent options that allow users to consent to certain data uses while declining others, such as consenting to inventory management for personal use while declining participation in aggregated analytics. The platform 120 may further implement mechanisms to periodically prompt users to review and confirm their consent preferences, particularly when new data collection features are introduced or when privacy policies are updated.

FIG. 2 illustrates an example unit constraint engine 152, in accordance with implementations of the present disclosure. As described herein, unit constraint engine 152 can perform operations pertaining to constraint-based selection of discrete units from external data systems, including processing recipe content, normalizing ingredient representations, retrieving candidate product records, and generating machine-readable data structures identifying selected candidate product records. As illustrated in FIG. 2, unit constraint engine 152 can include a recipe extraction module 210, a normalization module 212, a candidate product unit module 214, an optimizer module 216, a data structure generator module 218, and/or an inventory management module 220. Details regarding unit constraint engine 152 are provided herein with respect to FIGS. 2-5. In some embodiments, platform 120, predictive system 180, and/or unit constraint engine 152 can be connected to memory 250 (e.g., via network 110, via a bus, etc.). Memory 250 can store recipe content 252, normalized ingredient representation(s) 254, candidate product record(s) 256, constraint(s) 258, product unit data structure(s) 260, order data 262, inventory data 264, and/or substitution data 266. Memory 250 can correspond to one or more regions of data store 112, in some embodiments. In other or similar embodiments, one or more portions of memory 250 can include or otherwise correspond to any memory of or connected to system architecture 100.

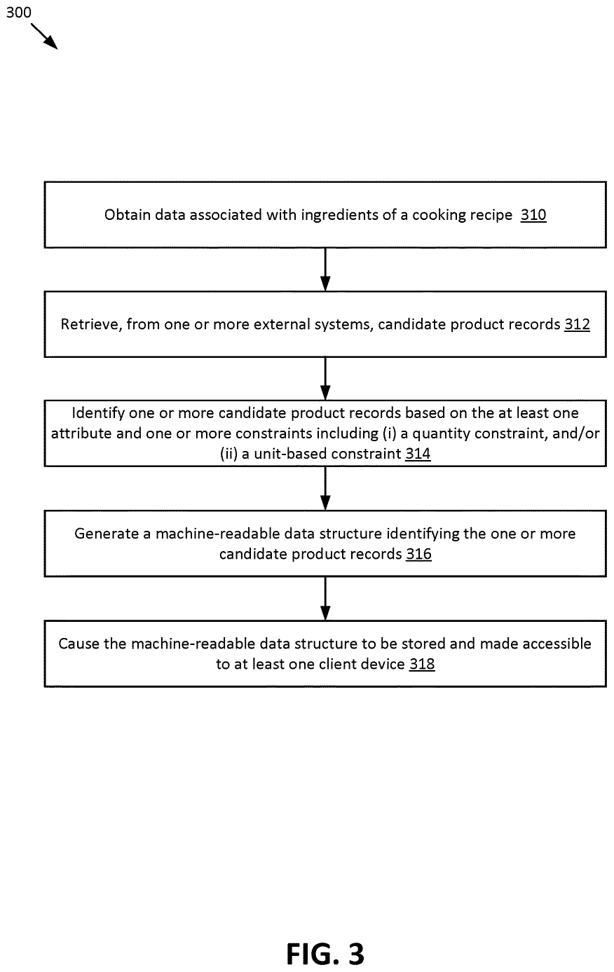

FIG. 3 is a flow diagram of an example method 300 for constraint-based selection of discrete units from external systems, in accordance with implementations of the present disclosure. Method 300 can be performed by processing logic that can include hardware (circuitry, dedicated logic, etc.), software (e.g., instructions run on a processing device), or a combination thereof. In one implementation, some or all the operations of method 300 can be performed by one or more components of system 100 of FIG. 1. In some embodiments, some or all of the operations of method 300 can be performed by unit constraint engine 151 and/or one or more components of predictive system 180.

At block 310, processing logic obtains data associated with ingredients of a cooking recipe. In some implementations, recipe extraction module 210 may obtain data associated with ingredients of a cooking recipe by processing recipe content 252 associated with the cooking recipe. The recipe content 252 may include image data, such as a photograph of a cookbook page or a screenshot of a recipe displayed on a mobile device, in some embodiments. In other or similar embodiments, the recipe content 252 may additionally or alternatively include video data, such as a cooking demonstration video or a social media reel containing recipe instructions. In yet other or similar embodiments, the recipe content 252 may additionally or alternatively include text data, such as free-form text typed by a user, a web page containing recipe information, or a transcript extracted from video content.

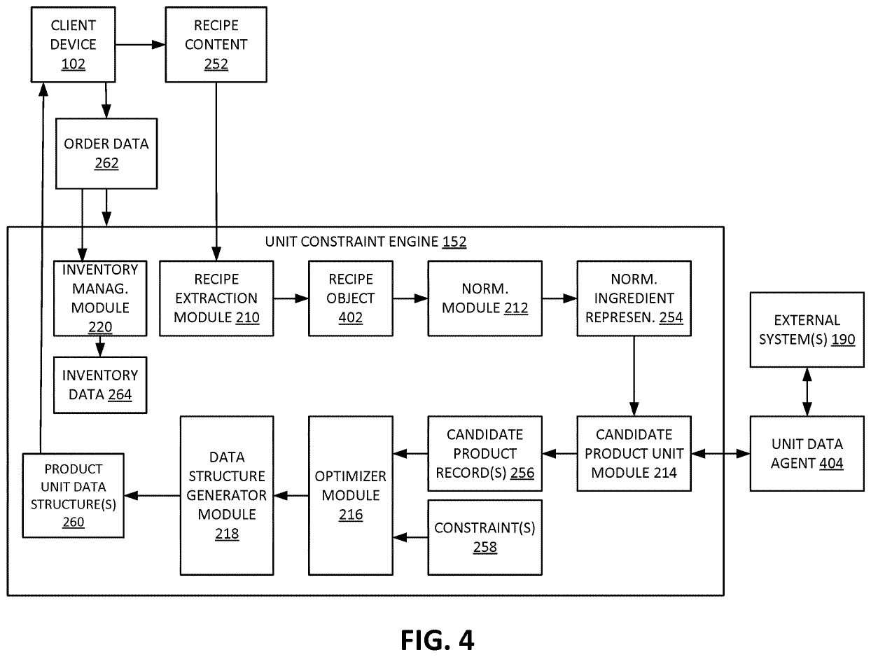

The unit constraint engine 152 may receive recipe content 252 through multiple pathways. In some implementations, the client device 102, as illustrated in FIG. 4, or kitchen station device 104 may transmit recipe content 252 directly to the unit constraint engine 152 via the API gateway 122, where a user has captured an image of a recipe, copied text from a website, or provided a URL linking to recipe content. In other implementations, the unit constraint engine 152 may retrieve recipe content 252 from memory 250 or data store 112, where recipe content has been previously stored by the platform 120 or uploaded by a user during a prior session. The unit constraint engine 152 may also receive recipe content 252 as part of a scheduled meal planning workflow, where recipes have been selected by a user and queued for ingredient processing. In yet other implementations, the unit constraint engine 152 may obtain recipe content 252 by querying external recipe databases or content providers accessible via network 110, retrieving recipe data based on user-specified search criteria or recommendations generated by the AI models 182 of predictive system 180.

In some embodiments, recipe extraction module 210 may detect an input type associated with the recipe content 252 based on metadata associated with the recipe content 252, such as uniform resource locator (URL) patterns, multipurpose internet mail extension (MIME) patterns, and/or uniform resource identifier (URI) prefixes. In some implementations, URL pattern detection may involve examining the domain portion of a URL to identify specific content platforms, such as video hosting services, social media platforms, recipe blogs, or general web pages. For example, the recipe extraction module 210 may detect that a URL corresponds to a video hosting platform based on domain matching against known video platform domains, and may accordingly route the recipe content 252 through a video transcript extraction path. Similarly, the recipe extraction module 210 may detect that a URL corresponds to a social media platform and route the recipe content 252 through a social media content extraction path that retrieves post captions, comments, and any associated media content. After obtaining raw text from social media content, the recipe extraction module 210 may scan the content for embedded URLs linking to external recipe sources, such as blog posts referenced in social media captions, and retrieve content from the linked sources to append to the raw text, enriching the unified representation with additional recipe details. For URLs corresponding to general web pages or recipe blogs, the recipe extraction module 210 may route the recipe content 252 through a web scraping path that extracts visible content from the page using techniques such as headless browser rendering or content extraction APIs. When primary web scraping techniques are unsuccessful, the recipe extraction module 210 may employ a fallback hierarchy including successive attempts using alternative content extraction methods, such as content extraction APIs or direct HTTP requests, until recipe content is successfully retrieved.

MIME type detection may be employed when the recipe content 252 is provided as uploaded file data or as base64-encoded data. The recipe extraction module 210 may examine MIME type headers or perform MIME type sniffing to determine whether the recipe content 252 includes image data (e.g., image/jpeg, image/png), video data (e.g., video/mp4), or text data (e.g., text/plain, text/html). Based on the detected MIME type, the recipe extraction module 210 routes the recipe content 252 through an appropriate processing path. For image data, the processing path may involve transmitting the image to an AI model configured to perform optical character recognition (OCR) to extract text from photographs of cookbook pages, handwritten recipes, or screenshots of recipe content. For video data, the processing path may involve extracting audio transcripts, closed captions, or performing frame-by-frame analysis to identify recipe instructions and ingredient lists.

URI prefix detection may be employed to identify recipe content 252 provided as data URIs or other URI schemes. For example, a base64-encoded data URI prefix (e.g., “data: image/png; base64,”) indicates that the recipe content 252 includes embedded image data that should be processed through the image extraction path. The recipe extraction module 210 may parse the URI prefix to extract both the content type and the encoding scheme, enabling appropriate decoding and routing of the recipe content 252.

In some embodiments, the recipe extraction module 210 may employ a fallback detection mechanism when primary detection methods are inconclusive. The fallback mechanism may involve content inspection techniques, such as examining initial bytes of the content to identify file signatures or magic numbers associated with specific file formats or applying heuristic analysis to determine whether the content includes structured markup, plain text, or binary data. The detection results inform the selection of processing paths and extraction strategies applied to the recipe content 252.

Upon routing the recipe content 252 through the appropriate processing path based on the detected input type, the recipe extraction module 210 performs format-specific extraction operations to obtain raw textual content. For image data, the recipe extraction module 210 may transmit the image to an AI vision model configured to perform optical character recognition, receiving extracted text representing recipe information visible in the image. For video URLs, the recipe extraction module 210 retrieves video transcripts, closed captions, or description text via platform-specific interfaces associated with the identified video platform. For web page URLs, the recipe extraction module 210 employs web scraping techniques such as headless browser rendering to extract visible content from the page. For plain text input, the text is used directly as the raw content without further processing. The raw textual content obtained from these format-specific extraction operations is then consolidated into the unified representation.

As illustrated in FIG. 4, recipe extraction module 210 may generate a unified representation of the recipe content 252 regardless of the original input format, and provide this unified representation as input to an AI model 182 to generate a structured recipe object 402. The structured recipe object 402 may include an indication of the ingredients, an amount of each ingredient, unit information, preparation instructions, and categorization information such as ingredient categories (e.g., produce, protein, dairy, grain, spice). The unified representation may include a normalized textual representation of the recipe content that abstracts away format-specific characteristics of the original input, enabling consistent downstream processing regardless of whether the recipe content 252 was originally provided as an image of a cookbook page, a video transcript, a social media post, or free-form text. In generating the unified representation, the recipe extraction module 210 may perform preprocessing operations including removal of extraneous metadata, formatting normalization, and content consolidation where recipe information is distributed across multiple sources such as a social media caption and a linked blog post. Upon generating the structured recipe object 402, the recipe extraction module 210 may persist the structured recipe object 402 to data store 112 and generate a vector embedding of the recipe content 252 for storage alongside the structured recipe object 402, enabling subsequent similarity-based searches and recipe recommendations.

The AI model 182 may be configured with a structured output schema that enforces generation of the structured recipe object 402 in a predefined format. The structured output schema may define required fields, data types, and allowed enumeration values for categorical fields, ensuring that the AI model 182 produces outputs that conform to expected data structures. In some implementations, the AI model 182 may operate in a strict schema mode that guarantees conformance to the defined schema, preventing omission of required fields or generation of unexpected data types. The AI model 182 may be configured with a low temperature parameter to prioritize deterministic, faithful extraction of recipe information over creative generation, reducing variability in outputs for similar inputs.

The structured recipe object 402 may further include a recipe title, a description of the dish, a serving count indicating the number of portions the recipe yields, preparation time and cooking time estimates, cuisine type classification, dish type classification, and dietary tags indicating characteristics such as gluten-free, vegetarian, or high-protein. The recipe extraction module 210 assigns a unique recipe identifier to the structured recipe object 402 and assigns unique ingredient identifiers to each ingredient in the ingredients list, enabling consistent referencing of the recipe and its constituent ingredients throughout subsequent processing operations. Each ingredient in the structured recipe object 402 may be associated with an ingredient identifier, an ingredient name, a numeric amount value, a unit string specifying the measurement unit, a preparation field indicating any preparation instructions specific to the ingredient (e.g., “diced,” “minced,” “peeled”), a category classification, and an optional flag indicating whether the ingredient is required or optional for the recipe. The cooking instructions within the structured recipe object 402 may be represented as an ordered sequence of instruction steps, each step including a step number, instruction text describing the action to be performed, and an optional duration estimate in minutes.

In some embodiments, the AI model 182 may be provided with a system prompt that instructs the model to act as a recipe extraction specialist and provides detailed rules for handling ingredient extraction. The rules may specify conventions for unit representation, such as using singular full unit names (e.g., “teaspoon” rather than “tsp”), default handling for ingredients without explicit quantities (e.g., defaulting spices to amount=1 and unit=“to taste”), separation of ingredient names from preparation instructions, and translation of non-English recipes into English during extraction. The system prompt may further instruct the AI model 182 to include only instruction steps that actually appear in the source content rather than generating additional steps not present in the original recipe content 252.

Normalization module 212 of unit constraint engine 152 may transform the ingredients of the cooking recipe indicated by the structured recipe object 402 into a set of normalized ingredient representations 254 by performing ingredient amount conversion operations to convert amounts into a common unit of measure, ingredient name resolution operations to resolve ingredient identifiers with standard ingredient identifiers using embedding-based matching techniques, and unit quantity standardization operations to generate unit quantities expressed in the common unit of measure. The ingredient amount conversion operations performed by normalization module 212 may involve converting between different measurement systems and unit types to establish a common unit of measure, such as ounces or grams, for all ingredients. In some implementations, the normalization module 212 maintains conversion tables that define relationships between volume units (e.g., tablespoon to teaspoon, cup to fluid ounce, gallon to liter), weight units (e.g., pound to ounce, ounce to gram, kilogram to pound), and ingredient-specific density values that enable conversion between volume measurements and weight measurements. For example, when a recipe specifies two cups of flour, the normalization module 212 may apply an ingredient-specific density value (e.g., 4.25 ounces per cup for all-purpose flour) to convert the volume measurement to a weight measurement of 8.5 ounces. Different ingredients may have different density values, such that one cup of honey converts to a different weight than one cup of olive oil. The normalization module 212 may further maintain count-to-weight conversion tables for ingredients commonly specified by count rather than by weight or volume, such as eggs, garlic cloves, individual fruits, or whole vegetables. For example, when a recipe specifies four garlic cloves, the normalization module 212 may apply an average weight per clove (e.g., 0.18 ounces per clove) to convert the count to a weight measurement of approximately 0.72 ounces.

The ingredient name resolution operations performed by normalization module 212 may involve resolving ingredient names as specified in the structured recipe object 402 to canonical ingredient identifiers maintained in a reference data structure. In some implementations, the normalization module 212 generates a vector embedding of the ingredient name using an embedding model, such as a text embedding model, and queries a canonical ingredients database containing pre-computed embeddings for known ingredients to identify the closest match using similarity metrics such as cosine similarity. When the similarity score exceeds a confidence threshold (e.g., 0.85), the normalization module 212 uses the matched canonical identifier. When the similarity score falls below the confidence threshold, the normalization module 212 may invoke an AI model 182 to classify the ingredient into the closest canonical identifier. The canonical ingredient identifiers enable consistent matching between recipe ingredients and candidate product records retrieved from external systems 190, even when ingredient names vary in spelling, abbreviation, or terminology across different recipe sources and retail product catalogs.

The unit quantity standardization operations performed by normalization module 212 generate standardized unit quantities expressed in the common unit of measure for each ingredient. The standardized unit quantities provide a consistent basis for comparison with unit quantities specified in candidate product records retrieved from external systems 190, enabling the optimizer module 216 to evaluate whether combinations of candidate product records satisfy the quantity constraint.

For ingredients subject to preparation losses, normalization module 212 may determine yield factors corresponding to preparation losses and adjust quantities accordingly, such as increasing purchase quantities for bone-in chicken when the recipe requires boneless portions. The yield factor determination performed by normalization module 212 accounts for preparation losses that occur when ingredients undergo transformation from their purchased form to their recipe-ready form. The normalization module 212 may maintain preparation form mapping data that associates ingredient preparation states (e.g., diced, minced, boneless, peeled) with corresponding product forms available from external systems 190 and yield factors indicating the fraction of purchased product that is usable after preparation. For example, bone-in, skin-on chicken thighs may have a yield factor of 0.70 when the recipe requires boneless portions, indicating that approximately 30% of the purchased weight is lost to bones and skin during preparation. When the recipe requires 24 ounces of boneless chicken, the normalization module 212 divides the required quantity by the yield factor (24÷0.70=34.3 ounces) to determine the adjusted purchase quantity. Similarly, whole onions may have a yield factor of 0.90 when the recipe requires diced onion, accounting for losses from peeling and trimming. The preparation form mapping data may further indicate labor requirements associated with different product forms, such as whether the user must perform preparation tasks (e.g., deboning, peeling, dicing) or whether pre-prepared product forms are available that require no additional user preparation. The normalization module 212 may generate normalized ingredient representations 254 that include both the recipe-required quantity and the yield-adjusted purchase quantity, enabling the optimizer module 216 to select candidate product records that satisfy the adjusted quantity requirements, as described below.

At block 312, processing logic retrieves, from one or more external systems, candidate product records. Each of the candidate product records 256 corresponds to a product available from the one or more external systems 190 and specifies a unit quantity of a respective ingredient of the ingredients provided by a unit of the product, and/or at least one attribute associated with the product. The at least one attribute may include one or more of a product weight attribute, a product availability indicator, a delivery characteristic, a quality indicator, or a cost indicator associated with the product. As used herein, the term “product weight attribute” refers to a data field or value that specifies the physical weight or mass of a product unit, which may be expressed in various units of measure such as ounces, pounds, grams, or kilograms. The product weight attribute may indicate the net weight of the product contents, the gross weight including packaging, or both. In some implementations, the product weight attribute may include an approximate or variable weight indicator (e.g., “~3.5 lb”) for products sold by weight where the exact weight may vary between individual units. As used herein, the term “product availability indicator” refers to a data element that specifies whether a product is currently in stock, available for purchase, or accessible through a particular fulfillment method at a given location or from a given external system. The product availability indicator may include binary availability states (e.g., in stock or out of stock), quantitative stock level information, or availability status codes indicating conditions such as limited availability, backordered, or available for pre-order. As used herein, the term “delivery characteristic” refers to one or more attributes describing the fulfillment options, logistics, or distribution parameters associated with a product. Delivery characteristics may include, but are not limited to, available fulfillment methods (e.g., pickup, delivery, drive-up), estimated delivery or ready times, delivery fee amounts, delivery minimum thresholds, geographic delivery zones, and store location identifiers for pickup fulfillment. As used herein, the term “quality indicator” refers to a data attribute that specifies one or more quality-related characteristics of a product, which may include product grade classifications, certification designations (e.g., organic, non-GMO, grass-fed), brand tier classifications (e.g., budget, mid-tier, premium), freshness indicators, or other attributes that distinguish products based on quality characteristics relevant to consumer preferences or dietary requirements. As used herein, the term “cost indicator” refers to a data attribute that specifies pricing information associated with a product, which may include the unit price for a single product unit, the unit price per weight (e.g., price per ounce), promotional or discounted pricing, loyalty program pricing, subscription pricing, or other cost-related values that enable comparison of product costs across different products, package sizes, or external systems.

In some implementations, candidate product unit module 214 of unit constraint engine 152 retrieves candidate product records 256 from external systems 190 by interfacing with application programming interfaces (APIs) exposed by the external systems 190 or by employing web scraping techniques to extract product information from web-based interfaces. The external systems 190 may include grocery retailers, wholesale distributors, specialty food suppliers, or other commercial entities that maintain product catalogs. Each external system 190 may expose product catalogs through different interface mechanisms, and the candidate product unit module 214 may employ adapter components configured to interface with specific external systems 190 according to their respective API specifications or web interface structures. Where official APIs are available from an external system 190, the candidate product unit module 214 may preferentially use the API for reliability and structured data access. Where no API is available or where API access is limited, the candidate product unit module 214 may employ headless browser scraping techniques to extract product information from web pages rendered by the external system 190.

The candidate product unit module 214 may construct search queries based on the normalized ingredient representations 254 generated by normalization module 212. For each normalized ingredient representation 254, the candidate product unit module 214 may generate a search query that includes the canonical ingredient name, quantity information, and any preparation form specifications. For example, a normalized ingredient representation for “chicken thigh, 1.5 lb, boneless skinless” may be transformed into a search query such as “boneless skinless chicken thigh 1.5 lb” for submission to external systems 190. The candidate product unit module 214 may further include location information, such as a zip code or geographic coordinates associated with the user, in the search query to retrieve products available for delivery or pickup at locations proximate to the user. The candidate product unit module 214 may further receive a list of preferred external systems 190 specified by the user, limiting or prioritizing the search to external systems 190 that the user has indicated as preferred sources for grocery purchases.

In some embodiments, the candidate product unit module 214 may employ an AI agent architecture for retrieving candidate product records 256. The AI agent (e.g., unit data agent 404) may be implemented using an AI model 182 configured with tool-calling capabilities, wherein the AI model 182 is provided with a set of callable tools and autonomously decides which tools to invoke, in what order, and with what parameters. The callable tools may include a search tool for searching products at a specific external system 190 using a text query and location information, a product details tool for retrieving full details for a specific product by its product identifier, an availability check tool for verifying whether a specific product is in stock at a specific location, and a substitutes tool for retrieving acceptable substitutes for an ingredient from substitution data 266. The callable tools may further include a return results tool that the AI agent 404 invokes when it has collected sufficient product matches for a given ingredient, finalizing the output for that ingredient and signaling completion of the search process. The AI agent 404 may be initialized with a conversation context including a system message instructing the model to act as a grocery shopping agent whose task is to find the best matching products at each external system 190 for a given ingredient, and a user message containing the ingredient details, the constructed search query, the user's location information such as a zip code, and a list of preferred external systems 190 specified by the user. The AI agent 404 may be configured with a tool choice parameter set to automatic mode, enabling the AI model 182 to autonomously decide whether and which tools to invoke at each iteration. For each tool invocation, the candidate product unit module 214 executes the requested tool, appends the results to the conversation context as a tool response, and provides the updated conversation back to the AI model 182 for the next decision. The AI agent 404 may iteratively invoke tools to search multiple external systems 190, examine search results, refine queries when initial results are unsatisfactory, and compile a ranked set of candidate product records 256 for each ingredient. When the AI model 182 does not request any tool calls and instead responds with a text message, the candidate product unit module 214 may interpret this as an indication that suitable matches could not be found for the ingredient, log a warning, and proceed to the next ingredient in the list.

The candidate product records 256 retrieved by the candidate product unit module 214 may include product identifiers, product names, brand information, price information expressed in a monetary unit such as cents, package weight information expressed in weight units such as ounces or pounds, unit price information calculated as price per unit weight, stock availability indicators, fulfillment option indicators specifying available delivery or pickup methods, product URLs linking to product pages on the external system 190, image URLs linking to product images, and match confidence scores indicating how closely the product matches the ingredient specification. The candidate product unit module 214 may further annotate candidate product records 256 with notes explaining relevant details, such as surplus quantities that would result from purchasing a package larger than the required quantity. For example, a candidate product record for a 3-pound package of chicken thighs when only 1.5 pounds is required may include a note indicating “Package is 3 lb; recipe needs 1.5 lb. Surplus: 1.5 lb.”

The candidate product unit module 214 may retrieve candidate product records 256 from multiple external systems 190 for each ingredient, enabling subsequent comparison and selection across different retail sources. For a single ingredient, the candidate product unit module 214 may retrieve multiple candidate product records from each of several external systems 190, resulting in a collection of candidate product records 256 that represent different product options at different price points, package sizes, and quality levels. The candidate product unit module 214 may store the retrieved candidate product records 256 in memory 250 for subsequent processing by optimizer module 216.

At block 314, processing logic identifies one or more candidate product records based on one or more constraints including (i) a quantity constraint and/or (ii) a unit-based constraint. In some embodiments, the quantity constraint and/or the unit-based constraint can be stored at memory 250 as constraint(s) 258. The quantity constraint specifies that unit quantities specified by the one or more candidate product records satisfy quantities associated with the ingredients of the cooking recipe. The unit-based constraint corresponds to fixed unit quantities of the products and restricts quantities of units of the products to non-fractional values, reflecting the discrete nature of unit-based representations in the external systems 190. Products available from external systems 190 are sold in fixed, indivisible quantities rather than arbitrary fractional amounts, such that a user cannot purchase half a can of tomatoes or a quarter of a bag of flour. The unit-based constraint ensures that selected candidate product records correspond to whole number quantities of purchasable units.

The constraints 258 may originate from multiple sources and may be configured, learned, or derived through various mechanisms. In some implementations, a developer or administrator of system architecture 100 may define base constraints during system configuration, including the unit-based constraint that enforces non-fractional product quantities and default coverage constraints that ensure ingredient requirements are satisfied. These developer-defined constraints may be stored in configuration files, database tables, or other persistent storage accessible to the unit constraint engine 152. In other or similar implementations, constraints 258 may be derived from data obtained from external systems 190, such as delivery minimum thresholds, maximum order quantities, or availability restrictions that are retrieved along with candidate product records 256 and dynamically incorporated into the constraint set. In yet other implementations, constraints 258 may be learned or refined over time based on historical user behavior, order outcomes, and feedback data. For example, the platform 120 may analyze historical order data to identify patterns indicating user preferences for consolidating orders at fewer retail entities, and may accordingly adjust maximum retail entity constraints or delivery preference constraints based on the learned patterns. The AI models 182 of predictive system 180 may be trained on historical constraint satisfaction outcomes to predict optimal constraint configurations for different user contexts, ingredient combinations, or external system availability conditions. User-specified preferences, such as preferred retail entities, budget limits, or quality requirements, may also be received via client device 102 and incorporated into the constraints 258 for a particular optimization operation. The combination of developer-defined base constraints, dynamically retrieved external system constraints, learned constraint adjustments, and user-specified preferences enables the optimizer module 216 to operate with a constraint set that reflects both system-level requirements and individualized user contexts.

In some implementations, optimizer module 216 of unit constraint engine 152 identifies the one or more candidate product records 256 by providing at least the candidate product records 256 and the one or more constraints 258 as an input to an optimization function. The optimization function may be implemented as a mixed-integer linear programming (MILP) solver that finds combinations of candidate product records that minimize a cost objective while satisfying the defined constraints. The term “mixed-integer” refers to the combination of integer decision variables (representing whole number quantities of product units to purchase) and binary decision variables (representing whether a particular external system 190 is used at all). The term “linear” refers to the linear nature of the objective function and constraint equations.

The optimization function receives as input the candidate product records 256, each specifying a unit quantity and at least one attribute such as a cost indicator, and the constraints 258 including the quantity constraint and the unit-based constraint. The objective function of the optimization may be defined to minimize the total cost, calculated as the sum of product prices multiplied by their respective quantities, plus any delivery fees or service fees associated with each external system 190 from which products are selected. The optimizer module 216 obtains one or more outputs of the optimization function, the outputs indicating quantities of units of the products associated with the candidate product records 256 based on the at least one attribute and the one or more constraints 258. The optimizer module 216 selects the one or more candidate product records corresponding to the quantities of units specified by the outputs of the optimization function.

The constraints 258 provided to the optimization function may additionally or alternatively include coverage constraints that ensure every ingredient is fully covered by the selected candidate product records. For each ingredient, the coverage constraint specifies that the total weight purchased, calculated as the sum of package weight multiplied by quantity for all products covering that ingredient, must be greater than or equal to the required quantity for that ingredient as specified in the normalized ingredient representations 254. The constraints 258 may further include integer constraints that restrict all quantity decision variables to non-negative whole numbers, enforcing the unit-based constraint that prevents selection of fractional product units.

In some implementations, the constraints 258 may additionally or alternatively include retail entity activation constraints that model whether a particular external system 190 is used in the selected combination of candidate product records. When any product is selected from an external system 190, a binary activation variable for that external system is set to one, which may trigger inclusion of associated delivery fees or service fees in the objective function and activation of delivery minimum constraints. The constraints 258 my additionally or alternatively include delivery minimum constraints that specify that if an external system 190 is used, the total spend at that external system must meet or exceed a minimum order threshold associated with that external system. The constraints 258 may further include a maximum retail entity constraint that limits the total number of external systems 190 from which products may be selected, based on user preferences for consolidating orders at fewer retail entities for convenience.

In some implementations, the constraints 258 may additionally or alternatively include a substitution willingness constraint that governs which candidate product records 256 are eligible for consideration during optimization based on a user-configured flexibility level. The substitution willingness constraint may define multiple flexibility levels, such as a strict level that limits the optimizer module 216 to candidate product records corresponding to exact ingredient matches only, a moderate level that permits the optimizer module 216 to consider candidate product records corresponding to close substitutes (e.g., diced tomatoes as a substitute for crushed tomatoes), or a flexible level that permits the optimizer module 216 to consider candidate product records corresponding to any reasonable alternative ingredient. The substitution willingness constraint may be received as a user preference via client device 102 and stored as part of constraints 258 in memory 250. The optimizer module 216 may apply the substitution willingness constraint by filtering the set of candidate product records 256 prior to optimization, excluding candidate product records that correspond to substitute ingredients not permitted by the user's configured flexibility level.

In some implementations, the constraints 258 may additionally or alternatively include a freshness constraint for perishable ingredients. The freshness constraint considers a delivery estimated time of arrival associated with candidate product records 256 in relation to a perishability indicator and a shelf life associated with the corresponding ingredient. For perishable ingredients having shorter shelf lives, the freshness constraint may prioritize candidate product records associated with earlier delivery estimated times of arrival. For example, when selecting candidate product records for a perishable ingredient such as fresh chicken with a shelf life of three days, the optimizer module 216 may prefer a candidate product record with a delivery estimated time of arrival of two days over a candidate product record with a delivery estimated time of arrival of four days, even if the latter has a lower cost indicator. The freshness constraint may be implemented as a penalty term in the objective function that increases the effective cost of candidate product records with later delivery times for perishable ingredients, or as a hard constraint that excludes candidate product records whose delivery estimated time of arrival exceeds a threshold determined based on the ingredient's shelf life.

In some embodiments, the optimizer module 216 modifies the quantity constraint to account for inventory quantities corresponding to on-hand quantities of ingredients available in an inventory. The inventory management module 220 may query inventory data 264 to determine, for each ingredient of the cooking recipe, an on-hand quantity of that ingredient currently available in the user's inventory. The optimizer module 216 subtracts the on-hand quantity from the required quantity specified in the normalized ingredient representations 254 to determine a remaining need quantity that must be satisfied by the selected candidate product records. When the remaining need quantity is zero or negative, the ingredient is fully covered by existing inventory and no candidate product records need to be selected for that ingredient. When the remaining need quantity is positive, the coverage constraint is modified to require that the total weight purchased for that ingredient satisfies the remaining need quantity rather than the full required quantity.

The optimizer module 216 may employ various solver implementations to solve the optimization problem defined by the objective function and constraints. In some implementations, the optimizer module 216 may utilize linear programming libraries, constraint satisfaction solvers, or specialized optimization tools capable of handling mixed-integer linear programming problems. The solver identifies the combination of candidate product records and associated quantities that minimizes the objective function while satisfying all defined constraints, or returns an indication that no feasible solution exists if the constraints cannot be satisfied by any combination of available candidate product records.

At block 316, processing logic generates a machine-readable data structure identifying the one or more candidate product records. In some implementations, data structure generator module 218 of unit constraint engine 152 generates a machine-readable data structure, which may be stored as product unit data structure(s) 260 in memory 250. The data structure 260 encodes the selected candidate product records 256 identified by the optimizer module 216, including product identifiers, product names, quantities of units to be purchased, unit prices, total prices calculated as the product of unit price and quantity, package weights, required weights corresponding to the normalized ingredient representations 254, surplus weights calculated as the difference between purchased weight and required weight, and mappings between each selected candidate product record and the corresponding ingredient of the cooking recipe. The data structure 260 may further encode retail entity identifiers indicating the external system 190 from which each selected product is to be obtained, enabling subsequent grouping of products by retail entity for order placement operations. The data structure 260 may further include user location information such as a zip code associated with the user, and a recipe title associated with the cooking recipe.

The data structure generator module 218 may encode the machine-readable data structure in a structured format such as JavaScript Object Notation (JSON), extensible markup language (XML), or another serialization format suitable for transmission to client devices and processing by downstream system components. The data structure 260 may include a data structure identifier that uniquely identifies the generated data structure, a recipe identifier linking the data structure to the corresponding cooking recipe, a timestamp indicating when the data structure was generated, and an expiration indicator specifying a time after which the data structure should be considered stale due to potential changes in product availability or pricing at external systems 190. The data structure generator module 218 may persist the data structure 260 to data store 112 with an associated expiration duration, after which the data structure 260 is considered stale and may be invalidated or regenerated to reflect current product availability and pricing at external systems 190.

For each selected candidate product record, the data structure 260 may include an ingredient identifier linking the product to the corresponding ingredient, the canonical ingredient name, the retail entity identifier, the product identifier as assigned by the external system 190, the product name, brand information, the quantity of units to be purchased, the unit price expressed in a monetary unit such as cents, the total price for the quantity of units, the package weight expressed in the common unit of measure, the required weight as specified in the normalized ingredient representations 254, the surplus weight that will remain after the recipe requirements are satisfied, and a surplus action indicator specifying how the surplus should be handled, such as adding the surplus to the user's inventory for future use.

The data structure 260 may further include a cost summary section that aggregates cost information across all selected candidate product records. The cost summary may include a subtotal representing the sum of total prices for all selected products, delivery fee amounts associated with each retail entity from which products are selected, service fee amounts if applicable, tax estimates calculated based on applicable tax rates and product categories, and a total cost representing the sum of subtotal, fees, and taxes. The cost summary may further include a list of retail entity identifiers indicating which external systems 190 are represented in the selected products, a fulfillment method indicator specifying whether the products will be obtained via delivery, pickup, or other fulfillment mechanisms, and savings information comparing the total cost of the selected combination to alternative combinations or naive selection strategies. The cost summary may further include a formatted display string representing the total cost in a human-readable format suitable for presentation on client devices, such as a currency-formatted string.

In some embodiments, the data structure generator module 218 generates inventory deduction records as part of the machine-readable data structure, documenting ingredients that were fully or partially satisfied by on-hand quantities in the user's inventory rather than by selected candidate product records. Each inventory deduction record may include the ingredient identifier, the canonical ingredient name, the quantity deducted from inventory expressed in the common unit of measure, the remaining need quantity that was satisfied by selected candidate product records, and a note indicating whether the ingredient was fully covered by inventory or partially covered with the remainder satisfied by purchased products.

The data structure generator module 218 may further generate alternative data structures 260 representing different selection strategies or constraint configurations. For example, the data structure generator module 218 may generate an alternative data structure 260 representing a single-retail entity selection that consolidates all products at a single external system 190 for user convenience, even if the total cost is higher than the optimized multi-retail entity selection. The data structure generator module 218 may generate another alternative data structure 260 representing a quality-prioritized selection that prefers candidate product records having quality indicators such as organic certification, even if such products have higher cost indicators. The data structure generator module 218 may generate yet another alternative data structure 260 representing a split-retail entity selection that increases the maximum number of external systems 190 from which products may be selected, allowing selection from additional external systems 190 for potentially lower individual product prices even though the user may need to coordinate multiple fulfillment windows. Each alternative data structure 260 may include a strategy identifier describing the selection strategy, the total cost for that strategy, the list of retail entities involved, and a note explaining the tradeoffs associated with that alternative. The alternative data structures 260 enable presentation of multiple options to the user via client device 102, allowing the user to make informed decisions based on cost, convenience, quality, or other considerations.

At block 318, processing logic causes the machine-readable data structure to be stored and made accessible to at least one client device. In some implementations, data structure generator module 218 causes the machine-readable data structure 260 to be stored in data store 112 and made accessible to at least one client device 102 via the API gateway 122. The platform 120 may transmit the data structure 260 to the client device 102 in response to a request from the client device 102, or may push the machine-readable data structure 260 to the client device 102 via webhook notifications when the data structure generation is complete. The client device 102 may render a user interface presenting the contents of the machine-readable data structure 260, including the selected candidate product records, associated quantities, prices, retail entity information, and any surplus quantities that will result from the purchase. The user interface may further present inventory deduction information indicating ingredients that were satisfied by on-hand quantities, cost summary information including subtotals, fees, and total costs, and alternative data structures 260 representing different selection strategies for user consideration.

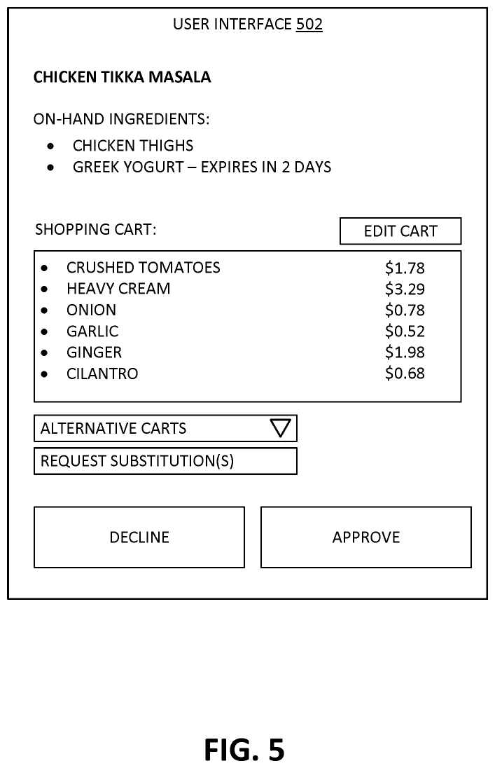

As illustrated in FIG. 5, the user interface 500 rendered on client device 102 may include a cart display region 510 presenting the selected candidate product records organized by ingredient or by retail entity. Each product entry in the cart display region 510 may include the product name, brand, quantity of units, unit price, total price, and an indication of any surplus quantity. The user interface 500 may further include an inventory deductions region 520 displaying ingredients that were fully or partially satisfied by on-hand inventory quantities, enabling the user to understand which ingredients did not require purchase. The user interface 500 may include a cost summary region 530 displaying the subtotal, delivery fees, service fees, tax estimates, and total cost for the selected products. The user interface 500 may further include an alternatives region 540 presenting alternative data structures 260 with different selection strategies, such as single-retail entity selections or quality-prioritized selections, enabling the user to compare options and select a preferred configuration.

The user interface 500 may include action controls 550 enabling the user to approve, modify, or decline the presented selection. An approval control may be rendered as a button or other interactive element that, when activated, causes the client device 102 to transmit an approval indication to the platform 120 via the API gateway 122. A modification control may enable the user to edit the cart contents, such as swapping products, adjusting quantities, removing items, or changing retail entities, before approving the modified selection. A decline control may enable the user to reject the presented selection without placing any orders. The user interface 500 may further include substitution controls enabling the user to request ingredient substitutions, triggering the platform 120 to identify substitute ingredients and regenerate the machine-readable data structure 260 with candidate product records corresponding to the substitute ingredients.

In some embodiments, the platform 120 may implement a price validation operation prior to presenting the data structure 260 to the client device 102 or prior to processing an approval indication received from the client device 102. The price validation operation may involve re-querying the external systems 190 to verify that the prices specified in the candidate product records 256 remain current, as prices at external systems 190 may change between the time the candidate product records were retrieved and the time the user reviews or approves the selection. The price validation operation may further verify that each product specified in the candidate product records 256 remains in stock at the respective external system 190. When the price validation operation detects that an item is no longer in stock, the platform 120 may flag the out-of-stock item for the user via the client device 102, enabling the user to select an alternative product or request regeneration of the machine-readable data structure 260. When the price validation operation detects that one or more prices have changed, the platform 120 may regenerate the machine-readable data structure 260 with updated price information, or may present a notification to the user via the client device 102 indicating which prices have changed and requesting confirmation before proceeding.

Upon receiving an approval indication from the client device 102 associated with the machine-readable data structure 260, the unit constraint engine 152 may initiate order placement operations. The unit constraint engine 152 groups the one or more candidate product records based on corresponding retail entities, creating separate order groups for each external system 190 from which products are to be obtained. For each retail entity group, the unit constraint engine 152 transmits, to a computing system associated with the corresponding retail entity, order data 262 corresponding to the grouped candidate product records to cause placement of an order for units of the products associated with the grouped candidate product records. The order data 262 may include product identifiers, quantities, fulfillment preferences (e.g., delivery or pickup), location information such as delivery addresses or pickup store identifiers, payment method information, and scheduled fulfillment times if specified by the user.

The unit constraint engine 152 may implement rollback logic to handle failures during order placement. When order placement fails at one external system 190 after orders have been successfully placed at other external systems 190, the unit constraint engine 152 may transmit cancellation requests to the external systems 190 where orders were successfully placed, preventing partial fulfillment scenarios where the user receives some but not all required ingredients. The unit constraint engine 152 may then return an error indication to the client device 102 specifying which external system 190 caused the failure and enabling the user to retry the order or select an alternative configuration.

Responsive to successful placement of the order, the inventory management module 220 generates one or more inventory update records for products having unit quantities that exceed quantities associated with corresponding ingredients. The inventory update records specify surplus quantities that should be added to the user's inventory for future use. For each product where the purchased package weight exceeds the required weight specified in the normalized ingredient representations 254, the inventory management module 220 creates an inventory update record indicating the surplus quantity, the canonical ingredient name, an appropriate storage location based on the ingredient category (e.g., freezer for meat, refrigerator for dairy, pantry for canned goods), and an estimated expiration date based on the ingredient's typical shelf life. The inventory update records may be queued for asynchronous processing by the inventory management module 220, which updates the inventory data 264 to reflect the surplus quantities available for future cooking sessions. This inventory management functionality enables the system to account for surplus quantities when processing subsequent cooking recipes, reducing redundant purchases and minimizing food waste.

Upon successful completion of order placement operations across all retail entity groups, the unit constraint engine 152 transmits an order confirmation to the client device 102. The order confirmation may include a platform-generated order identifier for the platform's own records, a confirmation status indicating successful placement, an array of retail entity-specific order confirmations each including the retail entity identifier, a retail entity-specific order identifier, the number of items ordered, the subtotal for that retail entity, an estimated ready or delivery time, the fulfillment method, and a store address for pickup fulfillment, and a flag indicating that inventory updates have been queued for asynchronous processing.

Responsive to successful placement of the order, the inventory management module 220 generates one or more inventory update records for products having unit quantities that exceed quantities associated with corresponding ingredients. The inventory update records specify surplus quantities that should be added to the user's inventory for future use. For each product where the purchased package weight exceeds the required weight specified in the normalized ingredient representations 254, the inventory management module 220 creates an inventory update record indicating the surplus quantity, the canonical ingredient name, an appropriate storage location based on the ingredient category (e.g., freezer for meat, refrigerator for dairy, pantry for canned goods), and an estimated expiration date based on the ingredient's typical shelf life. The inventory update records may be queued for asynchronous processing by the inventory management module 220, which updates the inventory data 264 to reflect the surplus quantities available for future cooking sessions. Upon processing the inventory update records, the inventory management module 220 may emit an inventory updated event to notify listening services or client devices that inventory data 264 has been modified, enabling real-time refresh of inventory displays on client device 102 or kitchen station device 104. This inventory management functionality enables the system to account for surplus quantities when processing subsequent cooking recipes, reducing redundant purchases and minimizing food waste. In some implementations, when the user subsequently confirms via client device 102 that the cooking recipe has been prepared, the inventory management module 220 deducts the ingredient quantities used from inventory data 264. The inventory management module 220 may employ a first-expired-first-out (FEFO) deduction strategy, consuming inventory items with the earliest expiration dates first, to minimize food waste from expired ingredients.

In some implementations, the inventory management module 220 may update inventory data 264 based on receipt images captured by the user via client device 102. The user may photograph a grocery receipt using the client device 102, and the inventory management module 220 may transmit the receipt image to an AI vision model configured to perform optical character recognition. The AI vision model extracts grocery item information from the receipt, including item names, quantities, and prices, and returns structured data representing the extracted items. For each item extracted from the receipt, the inventory management module 220 resolves the item name to a canonical ingredient name using embedding-based matching techniques similar to those employed by the normalization module 212, estimates the weight based on the product description, determines an appropriate storage location based on the ingredient category, estimates an expiration date based on the ingredient's typical shelf life, and inserts a new inventory item into inventory data 264. This receipt-based inventory update mechanism enables users to add items to their inventory without manual data entry, such as when the user purchases groceries in person rather than through the platform 120.

In some implementations, the inventory management module 220 may perform scheduled inventory maintenance operations to manage ingredient freshness and reduce food waste. The inventory management module 220 may execute a periodic sweep operation, such as a nightly scheduled job, that scans inventory data 264 to identify inventory items with expiration dates that have passed and updates the status of such items to indicate they are expired. The periodic sweep operation may further identify inventory items with expiration dates within a threshold period, such as within the next two days, and generate notifications to the user via client device 102 indicating the item name, quantity, and expiration date. The notification may include a suggestion to cook a recipe using the expiring ingredient. In some embodiments, the inventory management module 220 may proactively identify and suggest specific recipes from the user's saved recipe collection or from a recipe database maintained by platform 120 that include the expiring ingredient, enabling the user to plan meals that utilize ingredients before they expire.

In some implementations, the inventory management module 220 may receive manual inventory adjustment requests from the user via client device 102. The user may manually add items to inventory data 264, such as when the user brings home groceries purchased in person from a physical store, or manually remove items from inventory data 264, such as when the user discards spoiled food or corrects inaccurate quantities. The manual adjustment capability enables the user to maintain accurate inventory records even when inventory changes occur outside the automated workflows of platform 120.

In some implementations, the inventory management module 220 may synchronize inventory data 264 with smart kitchen devices via device-specific application programming interfaces. Smart kitchen devices may include smart refrigerators, connected scales, or other networked kitchen appliances capable of detecting inventory changes. When a smart refrigerator detects that an item has been removed, the smart refrigerator may transmit an indication to the inventory management module 220 via network 110, and the inventory management module 220 may decrement the corresponding quantity in inventory data 264 accordingly. This smart device synchronization enables real-time inventory updates without requiring manual user input.

In some implementations, the inventory management module 220 may provide extended inventory management capabilities for commercial kitchen environments. For commercial kitchens and catering businesses, the inventory management module 220 may support multi-station inventory organization, enabling inventory items to be associated with specific stations such as a prep station, hot line, cold line, walk-in cooler, or dry storage area. The inventory management module 220 may generate par-level alerts when inventory quantities for specified ingredients fall below configured minimum thresholds, enabling proactive reordering. The inventory management module 220 may support waste logging functionality for food cost analysis, supplier integration for automated reordering when inventory falls below par levels, batch number association for first-in-first-out compliance, and lot-number association for food safety traceability. These extended capabilities enable the platform 120 to support professional culinary operations in addition to home kitchen use cases.

In some implementations, when the inventory management module 220 processes ingredient deductions for a cooked recipe and determines that the remaining amount needed for an ingredient is greater than zero after processing all matching inventory items, the inventory management module 220 may record a shortfall indication. The shortfall indication indicates that the inventory did not contain sufficient quantity of the ingredient to fully satisfy the recipe requirements. The inventory management module 220 may transmit the shortfall indication to the client device 102 for presentation to the user, or may use the shortfall indication to suggest a purchase of the ingredient for future cooking sessions.

The following example illustrates the end-to-end operation of method 300 for a representative cooking recipe. A user provides, via client device 102, a URL linking to a recipe blog for a four-serving chicken tikka masala recipe. The recipe extraction module 210 detects the URL pattern, scrapes the web page content using headless browser rendering, and generates a unified representation of the recipe content. The AI model 182 processes the unified representation and generates a structured recipe object 402 specifying, among other ingredients, 1.5 pounds of boneless skinless chicken thigh, one cup of plain yogurt, one 14-ounce can of crushed tomatoes, four cloves of garlic (minced), and one tablespoon of garam masala. The normalization module 212 transforms these ingredients into normalized ingredient representations 254 by converting the chicken thigh quantity to 24 ounces using a direct weight conversion, converting the yogurt quantity from one cup to 8.6 ounces using an ingredient-specific density value, converting the garlic from four cloves to 0.72 ounces using a count-to-weight conversion table, and resolving each ingredient name to a canonical identifier via embedding-based matching (e.g., ‘plain yogurt’ resolves to ‘yogurt_plain’ with a cosine similarity score of 0.91). The inventory management module 220 queries inventory data 264 and determines that the user has 1.5 ounces of garam masala and 4.0 ounces of olive oil on hand, fully covering those ingredients. The optimizer module 216 modifies the quantity constraint to reflect a remaining need of zero for garam masala and olive oil, removing them from the set of ingredients requiring purchase. The candidate product unit module 214 dispatches the AI agent 404 to search three external systems for each remaining ingredient. For the chicken thigh ingredient, the AI agent 404 retrieves candidate product records including a 3-pound package priced at 789 cents from a first external system, a 1.25-pound package priced at 549 cents from a second external system, and a 3.5-pound family pack priced at 879 cents from a third external system.

The optimizer module 216 provides the candidate product records 256 and constraints 258 to the MILP solver. The constraints include the quantity constraint (e.g., total purchased weight of chicken must be at least 24 ounces), the unit-based constraint (quantities must be non-negative whole numbers), a delivery minimum constraint (total spend at each external system must meet or exceed the external system's minimum order threshold), and a maximum retail entity constraint (products may be selected from no more than two external systems). The MILP solver determines that selecting one unit of the 3-pound chicken package from the first external system at 789 cents, one unit of a 32-ounce yogurt container at 398 cents, one unit of a 28-ounce can of crushed tomatoes at 178 cents, and the remaining ingredients from the same external system minimizes total cost at 2,144 cents while satisfying all constraints. The data structure generator module 218 generates a machine-readable data structure 260 encoding the selected products, quantities, prices, surplus quantities (e.g., 24 ounces of surplus chicken from the 48-ounce package when only 24 ounces were needed), inventory deductions (garam masala and olive oil fully covered by on-hand quantities), a cost summary including subtotal, delivery fees, tax estimates, and total cost, and alternative data structures representing a single-retail entity selection at 2,389 cents and a split-retail entity selection at 2,298 cents. The data structure generator module 218 persists the data structure 260 to data store 112 with a two-hour expiration and transmits it to the client device 102 via the API gateway 122 for presentation to the user.

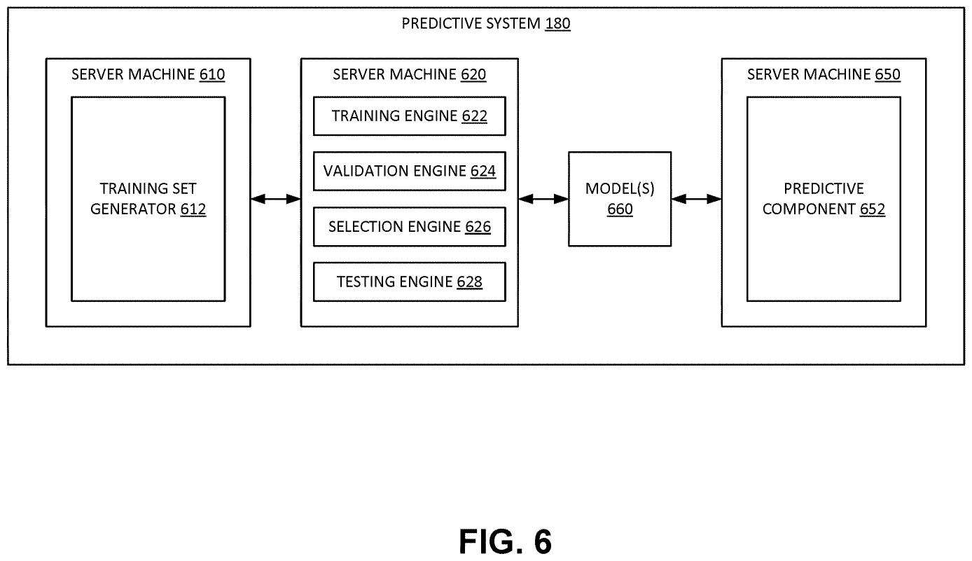

FIG. 6 illustrates an example predictive system 180, in accordance with implementations of the present disclosure. As illustrated in FIG. 6, predictive system 180 can include a training set generator 612 (e.g., residing at server machine 610), a training engine 622, a validation engine 624, a selection engine 626, and/or a testing engine 628 (e.g., each residing at server machine 620), and/or a predictive component 652 (e.g., residing at server machine 650). Training set generator 612 may be capable of generating training data (e.g., a set of training inputs and a set of target outputs) to train one or more model(s) 660. In some embodiments, model(s) 660 can include AI model 182 that processes recipe content, generates structured recipe objects, estimates session durations, predicts grocery costs, or generates recipe metadata, as described herein. The AI model 182 can be trained to extract structured recipe data from unstructured or semi-structured content, estimate cooking session durations based on dish complexity, or generate metadata tags for recipe indexing.

Training set generator 612 can generate a training dataset to train AI model 182 by obtaining a set of labeled training examples each associated with target structured outputs and recipe extraction results. In some embodiments, training set generator 612 can identify training data for inclusion in the training dataset from one or more data stores, which can include recipe content repositories, historical cooking session records, ingredient databases, and structured recipe objects maintained by or otherwise associated with platform 120. The training data can encompass a wide variety of recipe content formats, ingredient representations, cooking instructions, and session duration outcomes.

In some embodiments, training set generator 612 can generate training datasets for the AI model 182 that extracts structured recipe objects from unified representations of recipe content. Training set generator 612 may generate training data including recipe content in various formats such as image data, video data, and text data, paired with corresponding structured recipe objects containing indications of ingredients, amounts, units, preparation instructions, and categorization information. The training data may be derived from historical recipe records where structured representations have been manually verified, enabling the AI model 182 to learn to extract accurate structured data from diverse input formats.

For training the AI model 182 to estimate session durations for cooking service sessions, training set generator 612 may generate training data including input recipe data depicting various dish types, complexity levels, and cooking methods, paired with target duration estimates derived from actual recorded durations of historical cooking sessions. The target duration estimates may be derived from observed session data where cooking times have been recorded, enabling the AI model 182 to learn patterns for predicting session durations based on dish complexity, number of dishes, and nature of dishes in a planned menu.

For training the AI model 182 to predict grocery costs from ingredient-level dish data, training set generator 612 may generate training data including input ingredient lists with quantities and target cost values derived from historical purchase records. The target cost values may be generated by correlating ingredient specifications with actual purchase prices from external systems 190, enabling the AI model 182 to learn to infer costs based on complexity, quantity, and variety of ingredients across dishes. In some embodiments, the training data may incorporate normalized ingredient representations 254 generated by normalization module 212, where ingredient amounts have been converted to common units of measure and ingredient names have been resolved to standard ingredient identifiers using embedding-based matching techniques. The training set generator 612 may further include candidate product records 256 retrieved from external systems 190 as part of the training data, enabling the AI model 182 to learn associations between normalized ingredient representations and corresponding product attributes including product weight attributes, product availability indicators, delivery characteristics, quality indicators, and cost indicators. The training data may additionally incorporate constraint information from constraints 258, including quantity constraints specifying that unit quantities must satisfy ingredient requirements and unit-based constraints restricting quantities to non-fractional values, enabling the AI model 182 to learn cost prediction patterns that account for the discrete nature of unit-based representations in external systems 190. Training set generator 612 may generate training examples that pair structured recipe objects 402 containing indications of ingredients and amounts with corresponding product unit data structures 260 generated by data structure generator module 218, wherein the product unit data structures 260 encode selected candidate product records, quantities of units, unit prices, total prices, package weights, required weights, and surplus weights. The training data may further include inventory data 264 indicating on-hand quantities of ingredients, enabling the AI model 182 to learn to predict costs that account for inventory deductions where existing ingredients reduce the quantity of products that must be purchased. In some implementations, training set generator 612 may generate training examples incorporating yield factor adjustments performed by normalization module 212 for ingredients subject to preparation losses, enabling the AI model 182 to learn cost predictions that account for the difference between recipe-required quantities and yield-adjusted purchase quantities.

The training data may further include recipe metadata information such as dish type classifications, flavor profile indicators, cooking method classifications, preparation time estimates, and nutritional tags extracted from the input recipes, enabling the AI model 182 to learn associations between recipe content and standardized metadata categories. Training set generator 612 may also generate training data that includes various cuisine types and dietary categories, enabling the AI model 182 to learn to generate appropriate metadata tags for different recipe types based on ingredient compositions and cooking instructions.

For training the AI model 182 to perform tool-driven conversational interactions for recipe search operations, training set generator 612 may generate training data including user queries, tool invocation sequences, and target recipe recommendations that satisfy user-specified requirements. The training data may include multi-turn conversation examples where the AI model 182 interprets user intent, selects relevant tools such as SQL query generators or semantic search functions, and returns recipe recommendations based on interpreted filters, enabling the AI model 182 to learn autonomous tool selection and invocation patterns.

Training engine 622 can train the AI model 182 using the training data from training set generator 612. The AI model 182 can refer to the model artifact that is created by the training engine 622 using the training data that includes training inputs and corresponding target outputs. The training engine 622 can find patterns in the training data that map the training input to the target output and provide the AI model 182 that captures these patterns. The AI model 182 can be composed of, e.g., a single level of linear or non-linear operations or may be a deep network composed of multiple levels of non-linear operations. An example of a deep network is a neural network with one or more hidden layers, and such a machine learning model may be trained by, for example, adjusting weights of a neural network in accordance with a backpropagation learning algorithm or the like. In some embodiments, the AI model 182 can include, but is not limited to, a large language model (LLM), a vision-language model, a transformer-based model, a neural network (e.g., a convolutional neural network (CNN) based model, a recurrent neural network (RNN) or long short-term memory (LSTM) based model), and so forth.

In some embodiments, the AI model 182 may be trained to optimize an objective function that measures the accuracy of structured recipe extraction and the quality of generated outputs. For example, the AI model 182 may be trained using a loss function that penalizes inaccurate ingredient extraction, where the model learns to identify ingredient names, amounts, and units from diverse recipe content formats. The loss function may include multiple components, including an ingredient name accuracy component that measures the similarity between extracted ingredient names and ground truth ingredient names using metrics such as exact match accuracy or embedding-based similarity scores, an amount extraction component that penalizes numerical deviations between extracted amounts and ground truth amounts, and a unit classification component that measures the accuracy of unit identification across different measurement systems. The objective function may further include a structural consistency component that penalizes outputs that fail to conform to the expected schema of the structured recipe object 402, ensuring that the AI model 182 generates well-formed outputs with all required fields populated. In some implementations, the training process may employ curriculum learning techniques, where the AI model 182 is initially trained on simpler recipe content formats such as well-structured web pages with clear ingredient lists, and progressively exposed to more challenging formats such as images of handwritten recipes or video transcripts with informal language. The objective function may additionally incorporate a coverage component that encourages the AI model 182 to extract all ingredients present in the recipe content rather than omitting ingredients that are difficult to parse, and a precision component that discourages the model from hallucinating ingredients not present in the source content. For embodiments where the AI model 182 performs ingredient name resolution to canonical identifiers, the objective function may include a resolution accuracy component that measures the correctness of mappings between extracted ingredient names and standard ingredient identifiers maintained in the reference data structure used by normalization module 212. The training process may employ regularization techniques to prevent overfitting to specific recipe content sources or formats, enabling the AI model 182 to generalize across the heterogeneous landscape of recipe content encountered during inference.

The AI model 182 may also be trained using multi-turn conversational training techniques where the model proposes an initial estimate, then is prompted to revise its explanation to match ground truth data, enabling the model to generate reasoning that justifies predictions. For embodiments where the AI model 182 generates metadata tags based on recipe content, the training objective may include a classification accuracy term that encourages the generated tags to match verified metadata categories.

Validation engine 624 may be capable of validating each trained model using a corresponding set of features of a validation set from training set generator 612. The validation engine 624 may determine an accuracy of each of the trained AI models based on the corresponding sets of features of the validation set. The validation engine 624 may discard a trained AI model that has an accuracy that does not meet a threshold accuracy. In some embodiments, the selection engine 626 may be capable of selecting a trained model that has an accuracy that meets a threshold accuracy. In some embodiments, the selection engine 626 may be capable of selecting the trained AI model that has the highest accuracy of the trained AI models.

The testing engine 628 may be capable of testing each trained AI model using a corresponding set of features of a testing set from training set generator 612. For example, the AI model 182 that was trained to extract structured recipe objects may be tested using a held-out set of recipe content with known ingredient lists, amounts, and cooking instructions. The testing engine 628 may determine which trained models have the highest accuracy based on the testing sets, and these validated models may be deployed to the unit constraint engine 152 for use in processing recipe content and generating structured recipe objects.

As described above, predictive component 652 of server machine 650 may be configured to feed data as input to model(s) 660 and obtain one or more outputs. In some embodiments, predictive component 652 can include or be associated with unit constraint engine 152. In other or similar embodiments, predictive component 652 can include or be associated with another process or engine of system architecture 100. For example, predictive component 652 can be associated with the recipe extraction module 210, the normalization module 212, and/or the candidate product unit module 214 of unit constraint engine 152. Predictive component 652 can provide recipe content and ingredient data as inputs to model(s) 660 and can obtain one or more outputs including structured recipe objects, session duration estimates, and metadata tags. Unit constraint engine 152 and/or other processes or engines of system architecture 100 can use the structured recipe objects and other outputs obtained based on the one or more outputs for use in the performance of any type of operation described above (e.g., transforming recipe content into normalized ingredient representations, retrieving candidate product records from external systems 190, generating machine-readable data structures identifying selected candidate product records, etc.).

As described above, recipe extraction module 210 of unit constraint engine 152 can perform one or more operations associated with retraining an AI model (e.g., model(s) 660, AI model 182, etc.) for improved extraction of structured recipe data and generation of normalized ingredient representations. Details regarding retraining model(s) 660, AI model 182 are provided above with respect to FIG. 6. In some embodiments, recipe extraction module 210 can interface with or otherwise be associated with one or more components of predictive system 180. For example, recipe extraction module 210 may interface with training set generator 612 and/or training engine 622 to update the AI model 182 based on newly collected recipe content, verified structured recipe objects, and extraction accuracy metrics.

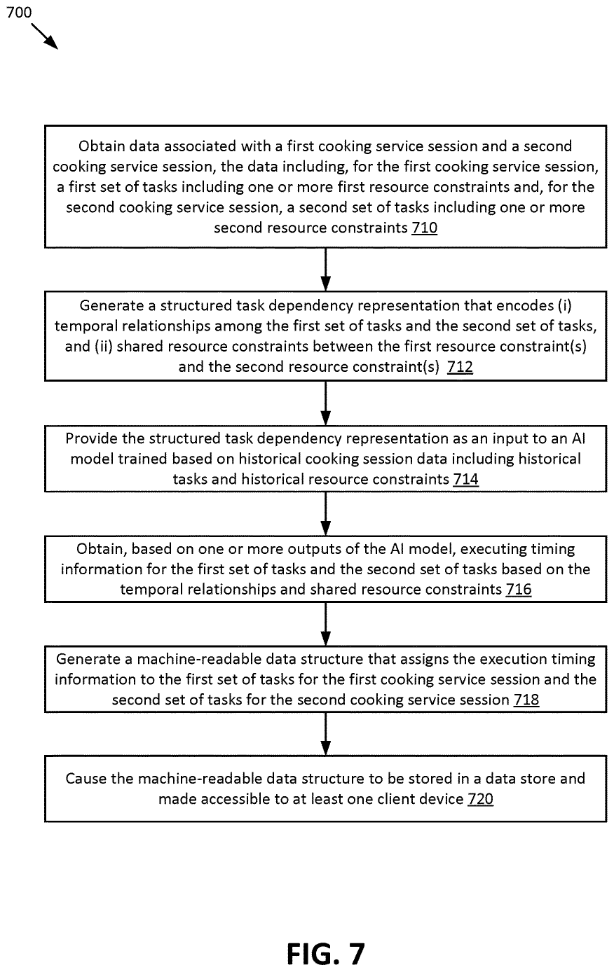

FIG. 7 is a flow diagram of an example method 700 for generating execution timing information for cooking service sessions, in accordance with implementations of the present disclosure. Method 700 can be performed by processing logic that can include hardware (circuitry, dedicated logic, etc.), software (e.g., instructions run on a processing device), or a combination thereof. In one implementation, some or all the operations of method 700 can be performed by one or more components of system 100 of FIG. 1. In some embodiments, some or all of the operations of method 700 can be performed by platform 120 and/or one or more components of predictive system 180.

At block 710, processing logic obtains data associated with a first cooking service session and a second cooking service session. The data includes, for the first cooking service session, a first set of tasks including one or more first resource constraints and, for the second cooking service session, a second set of tasks including one or more second resource constraints. In some implementations, the data associated with each cooking service session may include dish-level information such as recipe identifiers, ingredient lists, cooking instructions, and complexity indicators. The first set of tasks and the second set of tasks may each include preparation tasks, cooking tasks, plating tasks, and cleanup tasks associated with the respective cooking service sessions. The resource constraints may include equipment constraints specifying required cooking appliances or utensils, personnel constraints specifying required chef skill levels or staffing requirements, and temporal constraints specifying deadlines or service windows. In some embodiments, the processing logic retrieves session records from a database, such as data store 112, using an API. Each session record may include a unique session identifier, a status indicator (e.g., completed, scheduled, in-progress), and a duration value expressed in hours or minutes. The processing logic may select completed sessions with non-empty menus for analysis, enabling the system to leverage historical session data for training and prediction purposes.

At block 712, processing logic generates a structured task dependency representation that encodes temporal relationships among the first set of tasks and the second set of tasks, and shared resource constraints between the first resource constraint and the second resource constraint. The structured task dependency representation may encode predecessor-successor relationships between tasks, indicating which tasks must be completed before other tasks can begin. For example, a marination task may be a predecessor to a grilling task, and the structured task dependency representation encodes this temporal dependency. The structured task dependency representation may further encode parallelization opportunities, identifying tasks that can be executed concurrently when sufficient resources are available. Shared resource constraints may include shared equipment such as ovens, stovetops, or specialized appliances that cannot be used simultaneously by multiple tasks across the first cooking service session and the second cooking service session. In some implementations, the processing logic generates dish instruction data for each session by transmitting requests to a prediction endpoint. The response from the prediction endpoint may include a predicted duration value, a dishes_instructions field containing a narrative-style breakdown of cooking tasks for each dish, and a duration_reasoning field containing a preliminary explanation of the duration estimate. The dishes_instructions field may specify, for each dish, the preparation steps, cooking methods, timing requirements, and any special considerations that affect task duration.

At block 714, processing logic provides the structured task dependency representation as an input to an AI model trained based on historical cooking session data including historical tasks and historical resource constraints. The AI model may include a fine-tuned language model, such as a large language model (LLM) that has been trained on cooking session records combined with AI-generated cooking instructions and actual recorded durations from historical sessions. In some implementations, the AI model is trained using multi-turn conversational training techniques. Training data may be formatted into chat-style prompts including a system message, a user message, and assistant responses. The system message may instruct the AI model to act as an AI that calculates an estimated duration for a private cheffing session based on the complexity, number, and nature of dishes in the planned menu. The user message may contain the dishes and instructions extracted from the structured task dependency representation. The assistant response may include an estimated total time value and a reasoning field explaining the estimate. The training process may simulate a multi-turn conversation where the AI model proposes an initial estimate, then is prompted to revise its explanation to match ground truth data derived from actual recorded durations of historical cooking sessions. For example, a training sample may include an initial assistant response with a preliminary estimate, followed by a user message stating “It should be [actual_duration] min, please update your reasoning,” and a final assistant response with the corrected estimate and updated reasoning. This training approach enables the AI model to not only predict numerical duration values but also to generate reasoning that justifies the predictions, improving transparency and user trust in the system outputs.

At block 716, processing logic obtains, based on one or more outputs of the AI model, execution timing information for the first set of tasks and the second set of tasks based on the temporal relationships and shared resource constraints. The outputs of the AI model may include an estimated total session time expressed in hours or minutes, a per-dish breakdown of estimated preparation and cooking times, and an explanation justifying the duration estimate. The explanation may reference specific factors that influence the estimate, such as “Roasting chicken will take 90 minutes including prep; dessert is no-bake and needs 15 minutes of assembly.” The execution timing information may assign start times and end times to each task in the first set of tasks and the second set of tasks, accounting for the temporal dependencies and shared resource constraints encoded in the structured task dependency representation. In some implementations, the AI model outputs are formatted as structured data, such as JSON objects containing fields for estimated_total_time and reasoning. The processing logic parses these outputs to extract the execution timing information for assignment to individual tasks. The AI model may generate multiple estimates representing different scenarios, such as optimistic, average, and conservative duration estimates, enabling the system to provide confidence intervals or ranges for session duration predictions.

At block 718, processing logic generates a machine-readable data structure that assigns the execution timing information to the first set of tasks for the first cooking service session and the second set of tasks for the second cooking service session. The machine-readable data structure may be encoded in a format such as JSON or JSONL, enabling storage and transmission to client devices and other system components. The machine-readable data structure may include, for each task, a task identifier, a session identifier linking the task to its associated cooking service session, a start time, an end time, a duration value, and any resource assignments specifying equipment or personnel allocated to the task. The machine-readable data structure may further include the reasoning generated by the AI model, enabling presentation of explanatory information to users alongside the timing assignments. In some implementations, the machine-readable data structure includes a schedule representation that visualizes the temporal arrangement of tasks across both cooking service sessions, highlighting any periods of resource contention or idle time.

At block 720, processing logic causes the machine-readable data structure to be stored in a data store and made accessible to at least one client device. The machine-readable data structure may be stored in data store 112 with an associated session identifier and timestamp, enabling retrieval and presentation to users via client device 102 or kitchen station device 104. The client device may render a user interface presenting the execution timing information, including estimated session durations, task schedules, and explanatory reasoning generated by the AI model. In some implementations, the system transmits the machine-readable data structure to the client device via the API gateway 122, enabling real-time updates to scheduling displays as session parameters change. The execution timing information may be used for various downstream operations, including service session scheduling to prioritize and schedule sessions based on predicted duration, calendar integration to automatically block calendar time for sessions, time slot reservation to allocate optimal time slots, and capacity planning to forecast demand based on aggregate predictions. The system may further use the execution timing information for anomaly detection, flagging tasks with unusually predicted durations for further review, and for historical benchmarking, comparing actual versus predicted durations for continual model improvement.

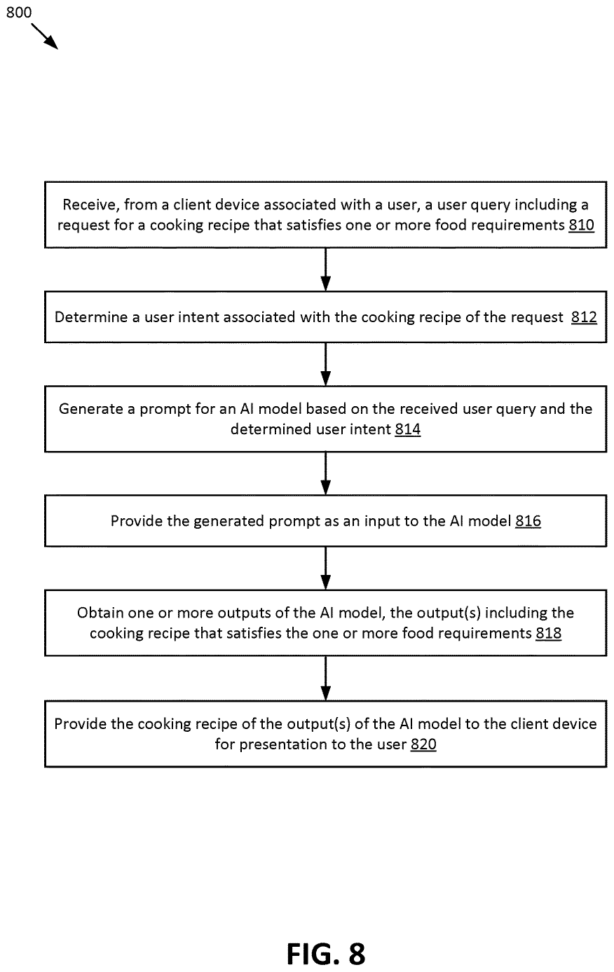

FIG. 8 is a flow diagram of an example method 800 for tool-driven conversational recipe search using artificial intelligence (AI), in accordance with implementations of the present disclosure. Method 800 can be performed by processing logic that can include hardware (circuitry, dedicated logic, etc.), software (e.g., instructions run on a processing device), or a combination thereof. In one implementation, some or all the operations of method 800 can be performed by one or more components of system 100 of FIG. 1. In some embodiments, some or all of the operations of method 800 can be performed by platform 120 and/or one or more components of predictive system 180.

At block 810, processing logic receives, from a client device associated with a user, a user query including a request for a cooking recipe that satisfies one or more food requirements. The user query may include a natural-language request that specifies explicit or implicit requirements, such as dietary restrictions, ingredient preferences, cuisine types, nutritional targets, or meal timing preferences. For example, the user query may include requests such as “I want a low-fat vegetarian dinner that's not spicy and uses tofu” or “I'm looking for a Mediterranean lunch with chickpeas that's high in protein.” The food requirements may include one or more of dietary constraints (e.g., vegetarian, vegan, gluten-free), ingredient inclusions or exclusions, cuisine type specifications, nutritional parameters (e.g., protein content, calorie limits), flavor profile preferences (e.g., savory, spicy, mild), cooking method preferences, or time-of-day suitability indicators.

At block 812, processing logic determines a user intent associated with the cooking recipe of the request. The user intent determination involves interpreting both explicit and implicit user needs from the natural-language query. Processing logic may apply culinary knowledge, including seasonality considerations, nutritional information, and ingredient pairing logic, to infer user intent beyond the literal text of the query. For example, a request for “a healthy weeknight dinner” may be interpreted as requiring recipes with moderate preparation time, balanced nutritional content, and commonly available ingredients. The user intent may encompass multiple dimensions including the type of dish sought, the context of consumption, the skill level required for preparation, and any unstated preferences that can be inferred from the query context or user history.

At block 814, processing logic generates a prompt for an AI model based on the received user query and the determined user intent. The prompt generation involves constructing a structured input that enables the AI model to perform function-driven reasoning across multiple tools. The AI model may be configured with a set of callable tools including a generateSQLQueries tool for producing SQL statements from interpreted filters such as diet, ingredients, and cuisine, a searchByRecipeDescription tool for performing semantic matching on free-form descriptions, a getSimilarRecipes tool for refining recommendations based on user reactions to suggested recipes, and a returnResults tool for finalizing the recommendation set. The prompt may include a system message that instructs the AI model to interpret user needs, use culinary knowledge for reasoning, generate SQL queries using field-specific operators (e.g., @>, ILIKE, BETWEEN), and chain tools as necessary for full resolution of the request. The prompt further instructs the AI model to delay using the returnResults tool until reasoning through search and logic operations is complete, ensuring that outputs reflect comprehensive evaluation of available options.

At block 816, processing logic provides the generated prompt as an input to the AI model. The AI model processes the prompt and autonomously decides which tools to invoke, in what order, and with what parameters. For each tool invocation, processing logic executes the requested tool, appends the results to the conversation context as a tool response, and provides the updated conversation back to the AI model for the next decision. The AI model may iteratively invoke tools to search recipe databases, examine search results, refine queries when initial results are unsatisfactory, and compile a ranked set of candidate recipes. For example, the AI model may use the generateSQLQueries tool to filter for recipes matching specified criteria such as cuisines, main ingredients, protein content, and time-of-day suitability, producing SQL statements with explanations and culinary notes justifying the query construction. The AI model implements a delay mechanism that prevents finalization of results until reasoning through search and logic operations is complete, ensuring that the user receives curated and contextually matched recommendations. The delay mechanism may include additional operations to ensure that preferences and allergens for the end user are reflected in the outputs, and may include logic that balances the amount of time for the delay with the quality of the output such that the delay is not excessive while the output quality is sufficient.

At block 818, processing logic obtains one or more outputs of the AI model, the outputs including the cooking recipe that satisfies the one or more food requirements. The outputs may include a ranked list of recipe recommendations, each accompanied by explanations of why the recipe satisfies the user's requirements. The AI model invokes the returnResults tool only after determining that the request has been fully satisfied through the function-driven reasoning process. The outputs may further include culinary notes explaining the selection logic, such as “Chickpeas are high in protein and popular in Mediterranean cuisine; these meals are often served cold or room temp, ideal for lunch.” When the AI model cannot find suitable matches through SQL-based filtering, it may employ fallback logic and rerouting to use semantic search as an alternative approach. The outputs may include multiple recipe options enabling the user to select among alternatives based on personal preferences not captured in the original query.

At block 820, processing logic provides the cooking recipe of the outputs of the AI model to the client device for presentation to the user. The presentation may include the recipe details, ingredient lists, preparation instructions, and explanatory information generated by the AI model during the reasoning process. The conversational nature of the interaction enables multi-turn dialogue where the user may provide feedback, request refinements, or ask follow-up questions, with the AI model continuing to apply function-driven reasoning to satisfy evolving user requirements. In some implementations, the system may integrate with grocery APIs for auto-cart generation based on the selected recipe, enabling seamless transition from recipe discovery to ingredient procurement through the constraint-based selection operations described with respect to method 300.

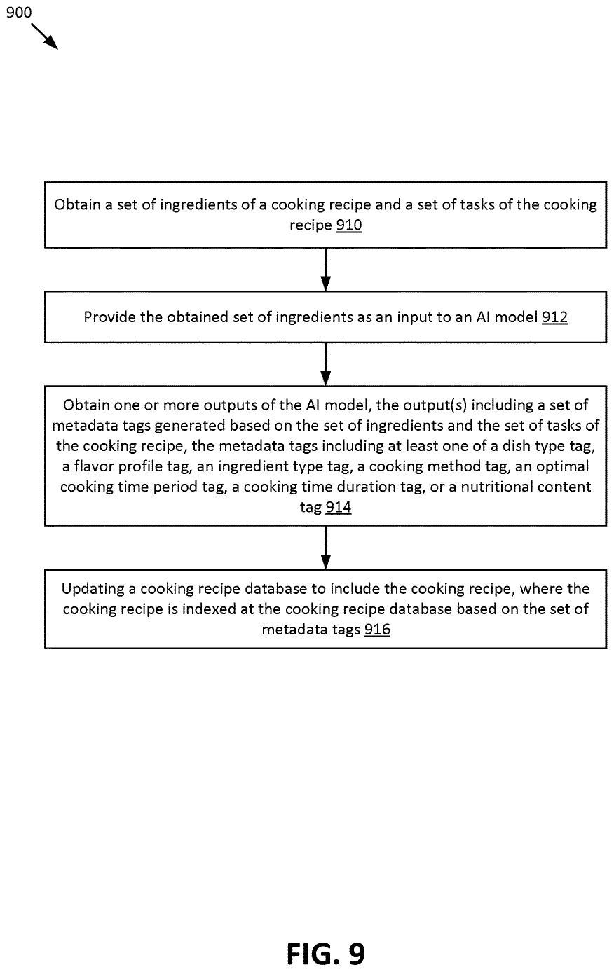

FIG. 9 is a flow diagram of an example method 900 for AI-based recipe metadata generation and database updating, in accordance with implementations of the present disclosure. Method 900 can be performed by processing logic that can include hardware (circuitry, dedicated logic, etc.), software (e.g., instructions run on a processing device), or a combination thereof. In one implementation, some or all the operations of method 900 can be performed by one or more components of system 100 of FIG. 1. In some embodiments, some or all of the operations of method 900 can be performed by platform 120 and/or one or more components of predictive system 180.

At block 910, processing logic obtains a set of ingredients of a cooking recipe and a set of tasks of the cooking recipe. In some implementations, the processing logic retrieves recipe data from a relational database, such as data store 112, where recipes, invoices, and cooking session data are stored. The recipe data may include unstructured or semi-structured information such as recipe name, description, ingredient list, category, cuisine, dietary preferences, and servings. The set of tasks may include preparation steps, cooking instructions, and timing information associated with the cooking recipe. In some embodiments, the processing logic connects to a database instance and pulls records from a recipes table, extracting fields including web links, ingredients lists, dietary preferences, preparation methods, and other recipe-related information.

At block 912, processing logic provides the obtained set of ingredients as an input to an AI model. In some implementations, the processing logic constructs a prompt that is dynamically generated using the recipe name, description, ingredient list formatted as readable text, category, cuisine, dietary preferences, and servings. The prompt may include a system message that instructs the AI model to return a structured output with pre-defined keys and options. For example, the system message may instruct the AI model to return a JSON object with fields including flavors, proteins, dish type, preparation time, time of day suitability, preparation method, cooking time, meat type, spice level, nutrition tags, and main ingredients. The system message may further specify that the AI model should use exact field names and return all numbers as strings. In some embodiments, the formatted prompt is transmitted to an AI model, such as a large language model (LLM), via an API endpoint for processing.

At block 914, processing logic obtains one or more outputs of the AI model. The outputs include a set of metadata tags generated based on the set of ingredients and the set of tasks of the cooking recipe. The metadata tags include at least one of a dish type tag (e.g., Appetizer, Main Course, Dessert), a flavor profile tag (e.g., Savory, Spicy, Sweet, Tangy), an ingredient type tag identifying main ingredients, a cooking method tag (e.g., Baking, Roasting, Grilling, Sautéing), an optimal cooking time period tag indicating time of day suitability (e.g., Breakfast, Lunch, Dinner, Brunch), a cooking time duration tag specifying preparation and cooking time estimates, or a nutritional content tag (e.g., Low-Fat, High-Protein, Gluten-Free, Vegetarian). In some implementations, the AI model outputs are formatted as structured data, such as JSON objects, that are parsed and validated by the processing logic. The metadata tags may further include a meat type tag (e.g., Chicken, Beef, Pork, Seafood, None), a spice level tag (e.g., Mild, Medium, Spicy), and a protein content value expressed in grams. The structured metadata output enables transformation of unstructured recipe collections into search-friendly and analytics-friendly databases. The metadata output from the AI model is specifically generated to follow a standardized indexing protocol, which enables the AI model or other AI models or systems to easily ingest and understand information of the recipe for purposes including search, personalization, recommendation, and analytics.

At block 916, processing logic updates a cooking recipe database to include the cooking recipe. The cooking recipe is indexed at the cooking recipe database based on the set of metadata tags. In some implementations, the processing logic parses the JSON response from the AI model and validates the metadata fields. The corresponding recipe record is then updated with the new metadata in the database using update operations via a database client. The enriched metadata fields enable complex filtering, dietary personalization, and trend analysis operations on the recipe database. In some embodiments, the system can scale to process large numbers of recipes with minimal manual intervention, ensuring uniform metadata across all recipes in the database. The standardized metadata enables downstream applications including recipe search engines, personalized meal planning systems, health applications recommending recipes based on macronutrient content, inventory-aware grocery list generators, and automated nutrition labeling for consumer platforms.

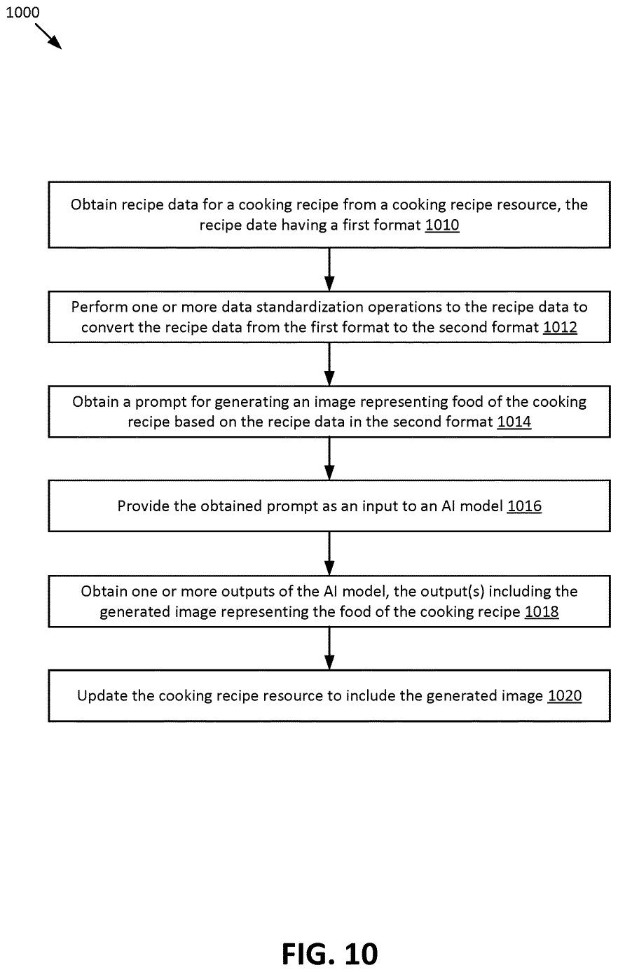

FIG. 10 is a flow diagram of an example method 1000 for generating an image representing food of a cooking recipe using an AI model, in accordance with implementations of the present disclosure. Method 1000 can be performed by processing logic that can include hardware (circuitry, dedicated logic, etc.), software (e.g., instructions run on a processing device), or a combination thereof. In one implementation, some or all the operations of method 1000 can be performed by one or more components of system 100 of FIG. 1. In some embodiments, some or all of the operations of method 1000 can be performed by platform 120 and/or one or more components of predictive system 180.

At block 1010, processing logic obtains recipe data for a cooking recipe from a cooking recipe resource, with the recipe data having a first format. In some implementations, the cooking recipe resource may include a web-based recipe source, a database such as data store 112, or another repository containing recipe information. The recipe data may include unstructured or semi-structured information such as recipe name, description, ingredient list, category, cuisine, dietary preferences, servings, and preparation methods. In some embodiments, the processing logic retrieves all records with valid web links from a recipes table in a database, skipping records with missing content or incompatible formats such as Google Docs links. The first format may include raw HTML content, markdown-formatted cooking instructions, or other unstructured textual representations of the recipe information.

At block 1012, processing logic performs one or more data standardization operations to the recipe data to convert the recipe data from the first format to a second format. In some implementations, the data standardization operations include scraping web-based recipe content using a scrape endpoint that extracts visible HTML content from recipe URLs. The scraping operation may return raw HTML text or markdown-formatted cooking instructions. A cleaning function may be applied to remove metadata and format the content into consistent fields, such as recipe name, ingredients, preparation time, cooking time, and step-by-step instructions. The second format may include a structured JSON-based recipe object containing standardized fields including ingredient lists, preparation methods, nutrition tags, and other recipe attributes. The data standardization operations transform diverse and inconsistent recipe formats from various sources into a uniform representation suitable for downstream processing by the AI model.

At block 1014, processing logic obtains a prompt for generating an image representing food of the cooking recipe based on the recipe data in the second format. In some implementations, the processing logic generates a natural-language food photography prompt suitable for visual AI workflows, such as generative image models or styled photography mockups. The prompt may specify styling characteristics appropriate for the particular dish, including camera settings, lighting conditions, backdrop materials, and garnish elements. For example, a prompt may include specifications such as “[Recipe Name] food photography, modern elegant styling, overhead macro shot, ceramic bowl, golden tones, soft diffused natural lighting, shot with Sony A 7R IV and 50 mm lens, f/4 aperture, white marble backdrop, warm color grading, Portra 400 film simulation, mint garnish and gold spoon.” In some embodiments, the processing logic employs an AI model to generate the prompt based on characteristics of the food and scene to be depicted. The AI model may intelligently identify camera settings for the AI-generated image based on characteristics of the food, with different settings selected for different food types and environmental contexts. For example, an image depicting a mug of hot chocolate in a wintery environment may have different camera or image settings than a plate of fish tacos in a sunny environment. A prompt generation engine or model may be trained to predict camera settings for an intended image based on historical image data depicting food and other objects in various environments.

At block 1016, processing logic provides the obtained prompt as an input to an AI model. In some implementations, the AI model includes a generative image model capable of producing visual representations based on natural-language prompts. The processing logic may transmit the prompt along with the structured recipe data to an AI model endpoint, such as an OpenAI chat completion endpoint. The input may be formatted as a conversational message structure including a system message instructing the model to convert recipe content into structured data with an associated image prompt, a user message containing the scraped and cleaned recipe content, and an expected assistant response format including both the structured recipe data and the generated image prompt. The AI model processes the combined input to generate both structured recipe information and a corresponding visual representation.

At block 1018, processing logic obtains one or more outputs of the AI model, with the outputs including the generated image representing the food of the cooking recipe. In some implementations, the outputs may further include the structured recipe data in the second format, such as a JSON object containing fields for recipe name, ingredients list, cooking time, preparation instructions, and the image prompt used for generation. The generated image may be suitable for use in applications including social media content, recipe platform displays, food photography mockups, or other visual presentations of the cooking recipe. The outputs may be formatted in a conversational JSONL format suitable for training data generation or downstream API use.

At block 1020, processing logic updates the cooking recipe resource to include the generated image. In some implementations, the processing logic stores the generated image in association with the corresponding recipe record in data store 112 or another database. The update operation may further include storing the structured recipe data in the second format, the image prompt used for generation, and any additional metadata generated during the processing pipeline. The updated cooking recipe resource enables digital platforms to display professional-quality visual representations alongside recipe content, supporting applications such as meal planning interfaces, recipe discovery systems, and culinary content platforms. In some embodiments, the processing logic may generate multiple image variations for a single recipe, enabling selection of preferred visual representations or A/B testing of different styling approaches.

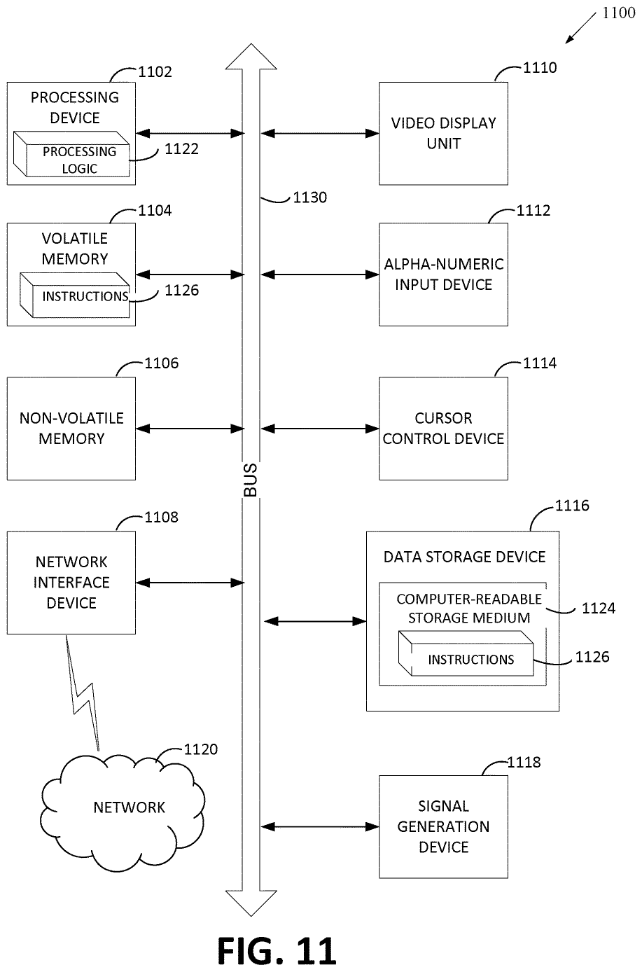

FIG. 11 is a block diagram illustrating an exemplary computer system 1100, in accordance with implementations of the present disclosure. The computer system 1100 can correspond to platform 120 and/or client device 102, described with respect to FIGS. 1-10. Computer system 1100 can operate in the capacity of a server or an endpoint machine in endpoint-server network environment, or as a peer machine in a peer-to-peer (or distributed) network environment. The machine can be a television, a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1100 includes a processing device 1102, a volatile memory 1104 (e.g., read-only memory (ROM), flash memory, dynamic random access memory (DRAM) such as synchronous DRAM (SDRAM), double data rate (DDR SDRAM), or DRAM (RDRAM), etc.), a non-volatile memory 1106 (e.g., flash memory, static random access memory (SRAM), etc.), and a data storage device 1116, which communicate with each other via a bus 1130.

Processing device 1102 represents one or more general-purpose processing devices such as a microprocessor, central processing unit, or the like. More particularly, the processing device 1102 can be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 1102 can also be one or more special-purpose processing devices such as an application specific integrated circuit (ASIC), a field programmable gate array (FPGA), a digital signal processor (DSP), network processor, or the like. The processing device 1102 includes processing logic 1122 configured to execute instructions 1126 for performing the operations discussed herein.

The computer system 1100 can further include a network interface device 1108. The computer system 1100 also can include a video display unit 1110 (e.g., a liquid crystal display (LCD) or a cathode ray tube (CRT)), an alpha-numeric input device 1112 (e.g., a keyboard, and alphanumeric keyboard, a motion sensing input device, touch screen), a cursor control device 1114 (e.g., a mouse), and a signal generation device 1118 (e.g., a speaker).

The data storage device 1116 can include a computer-readable storage medium 1124 (also machine-readable storage medium) on which is stored one or more sets of instructions 1126 embodying any one or more of the methodologies or functions described herein. The instructions 1126 can also reside, completely or at least partially, within the volatile memory 1104 and/or within the processing device 1102 during execution thereof by the computer system 1100, the volatile memory 1104 and the processing device 1102 also constituting machine-readable storage media. The instructions 1126 can further be transmitted or received over a network 1120 via the network interface device 1108.

In one implementation, the instructions 1126 include instructions for constraint-based selection of discrete units from external data systems. While the computer-readable storage medium 1124 (machine-readable storage medium) is shown in an exemplary implementation to be a single medium, the terms “computer-readable storage medium” and “machine-readable storage medium” should be taken to include a single medium or multiple media (e.g., a centralized or distributed database, and/or associated caches and servers) that store the one or more sets of instructions. The terms “computer-readable storage medium” and “machine-readable storage medium” shall also be taken to include any medium that is capable of storing, encoding or carrying a set of instructions for execution by the machine and that cause the machine to perform any one or more of the methodologies of the present disclosure. The terms “computer-readable storage medium” and “machine-readable storage medium” shall accordingly be taken to include, but not be limited to, solid-state memories, optical media, and magnetic media.

Reference throughout this specification to “one implementation,” “one embodiment,” “an implementation,” or “an embodiment,” means that a particular feature, structure, or characteristic described in connection with the implementation and/or embodiment is included in at least one implementation and/or embodiment. Thus, the appearances of the phrase “in one implementation,” or “in an implementation,” in various places throughout this specification can, but are not necessarily, referring to the same implementation, depending on the circumstances. Furthermore, the particular features, structures, or characteristics can be combined in any suitable manner in one or more implementations.

To the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), software, a combination of hardware and software, or an entity related to an operational machine with one or more specific functionalities. For example, a component can be, but is not limited to being, a process running on a processor (e.g., digital signal processor), a processor, an object, an executable, a thread of execution, a program, and/or a computer. By way of illustration, both an application running on a controller and the controller can be a component. One or more components can reside within a process and/or thread of execution and a component can be localized on one computer and/or distributed between two or more computers. Further, a “device” can come in the form of specially designed hardware; generalized hardware made specialized by the execution of software thereon that enables hardware to perform specific functions; software on a computer readable medium; or a combination thereof.

The aforementioned systems, circuits, modules, and so on have been described with respect to interact between several components and/or blocks. It can be appreciated that such systems, circuits, components, blocks, and so forth can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components can be combined into a single component providing aggregate functionality or divided into several separate sub-components, and any one or more middle layers, such as a management layer, can be provided to communicatively couple to such sub-components in order to provide integrated functionality. Any components described herein can also interact with one or more other components not specifically described herein but known by those of skill in the art.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Finally, implementations described herein include collection of data describing a user and/or activities of a user. In one implementation, such data is only collected upon the user providing consent to the collection of this data. In some implementations, a user is prompted to explicitly allow data collection. Further, the user can opt-in or opt-out of participating in such data collection activities. In one implementation, the collected data is anonymized prior to performing any analysis to obtain any statistical patterns so that the identity of the user cannot be determined from the collected data.

What is claimed is:

1. A method comprising:
obtaining, by a computing system, data associated with a plurality of ingredients of a cooking recipe;
retrieving, from one or more external systems, a plurality of candidate product records, wherein each candidate product record of the plurality of candidate product records corresponds to a product available from the one or more external systems and specifies (i) a unit quantity of a respective ingredient of the plurality of ingredients provided by a unit of the product, and (ii) at least one attribute associated with the product;
identifying, among the plurality of candidate product records, one or more candidate product records based on the at least one attribute and one or more constraints including: (i) a quantity constraint in which unit quantities specified by the one or more candidate product records satisfy a quantity associated with the plurality of ingredients, and (ii) a unit-based constraint corresponding to fixed unit quantities of the products;
generating a machine-readable data structure identifying the one or more candidate product records; and
causing the machine-readable data structure to be stored and made accessible to at least one client device.

2. The method of claim 1, wherein identifying the one or more candidate product records comprises:
providing at least the plurality of candidate product records and the one or more constraints as an input to an optimization function;
obtaining one or more outputs of the optimization function, the one or more outputs indicating quantities of units of the products associated with the plurality of candidate product records based on the at least one attribute and the one or more constraints; and
selecting the one or more candidate product records corresponding to the quantities of units specified by the one or more outputs of the optimization function.

3. The method of claim 1, wherein the unit-based constraint restricts quantities of units of the products to non-fractional values.

4. The method of claim 1, further comprising:
obtaining recipe content associated with the cooking recipe, wherein the recipe content comprises at least one of image data, video data, or text data associated with the cooking recipe; and
generating a unified representation of the recipe content.

5. The method of claim 4, further comprising:
generating, from the unified representation using an artificial intelligence (AI) model, a structured recipe object comprising an indication of the plurality of ingredients and an amount of each of the plurality of ingredients; and
transforming the plurality of ingredients indicated by the structured recipe object into a set of normalized ingredient representations by performing one or more of:
an ingredient amount conversion operation to convert the amount of each of the plurality of ingredients into a common unit of measure;
an ingredient name resolution operation to resolve identifiers associated with each of the plurality of ingredients with a standard ingredient identifier; or
a unit quantity standardization operation to generate, for each of the plurality of ingredients, a unit quantity expressed in the common unit of measure,
wherein the plurality of candidate product records is retrieved based on the set of normalized ingredient representations.

6. The method of claim 5, wherein transforming the plurality of ingredients further comprises:
determining, for at least one ingredient of the plurality of ingredients, a yield factor corresponding to a preparation loss associated with the at least one ingredient; and
adjusting a quantity associated with the at least one ingredient based on the yield factor.

7. The method of claim 4, wherein obtaining the recipe content comprises:
detecting an input type associated with the recipe content based on at least one of a uniform resource locator (URL) pattern, a multipurpose internet mail extension (MIME) pattern or a uniform resource identifier (URI) prefix;
routing the recipe content through a processing path corresponding to the detected input type.

8. The method of claim 1, further comprising:
determining, for at least one ingredient of the plurality of ingredients, an inventory quantity corresponding to an on-hand quantity of the at least one ingredient available in an inventory; and
modifying the quantity constraint to account for the inventory quantity.

9. The method of claim 8, wherein determining the inventory quantity comprises:
querying an inventory data store comprising one or more entries, each entry corresponding to a respective on-hand ingredient available in the inventory;
based on the querying, identifying one or more on-hand ingredients having an expiration time within a threshold of a current time; and
updating the inventory quantity based on the on-hand quantity of the identified one or more on-hand ingredients.

10. The method of claim 1, further comprising:
receiving a request to substitute at least one ingredient of the plurality of ingredients; and
responsive to the request, identifying one or more substitute ingredients for the at least one ingredient of the plurality of ingredients based on a substitution data structure comprising mappings between ingredients and substitute ingredients,
wherein one or more candidate product records of the plurality of candidate product records corresponds to the one or more substitute ingredients.

11. The method of claim 1, further comprising:
receiving, from the at least one client device, an approval indication associated with the machine-readable data structure;
grouping the one or more candidate product records based on corresponding retail entities;
transmitting, to a computing system associated with each corresponding retail entity, order data corresponding to the grouped candidate product records to cause placement of an order for units of the products associated with the grouped candidate product records; and
responsive to transmitting the order data, generating one or more inventory update records for products having unit quantities that exceed quantities associated with corresponding ingredients of the plurality of ingredients.

12. The method of claim 1, wherein the at least one attribute comprises one or more of: a product weight attribute, a product availability indicator, a delivery characteristic, a quality indicator, or a cost indicator associated with the product.

13. The method of claim 1, further comprising:
generating one or more alternative machine-readable data structures by identifying alternative candidate product records of the plurality of candidate product records subject to at least one or more additional constraints, wherein the one or more additional constraints comprise at least one of: (i) a single-retail entity constraint limiting selection of candidate product records to products available from a single retail entity, or (ii) a product preference constraints prioritizing candidate product records having a specified attribute value; and
causing the one or more alternative machine-readable data structures to be presented to the at least one client device for selection by a user.

14. A system comprising:
a memory; and
a set of one or more processing devices coupled to the memory, the set of one or more processing devices configured to perform operations comprising:
obtaining, by a computing system, data associated with a plurality of ingredients of a cooking recipe;
retrieving, from one or more external systems, a plurality of candidate product records, wherein each candidate product record of the plurality of candidate product records corresponds to a product available from the one or more external systems and specifies (i) a unit quantity of a respective ingredient of the plurality of ingredients provided by a unit of the product, and (ii) at least one attribute associated with the product;
identifying, among the plurality of candidate product records, one or more candidate product records based on the at least one attribute and one or more constraints including: (i) a quantity constraint in which unit quantities specified by the one or more candidate product records satisfy a quantity associated with the plurality of ingredients, and (ii) a unit-based constraint corresponding to fixed unit quantities of the products;
generating a machine-readable data structure identifying the one or more candidate product records; and
causing the machine-readable data structure to be stored and made accessible to at least one client device.

15. The system of claim 14, wherein identifying the one or more candidate product records comprises:
providing at least the plurality of candidate product records and the one or more constraints as an input to an optimization function;
obtaining one or more outputs of the optimization function, the one or more outputs indicating quantities of units of the products associated with the plurality of candidate product records based on the at least one attribute and the one or more constraints; and
selecting the one or more candidate product records corresponding to the quantities of units specified by the one or more outputs of the optimization function.

16. The system of claim 14, wherein the unit-based constraint restricts quantities of units of the products to non-fractional values.

17. The system of claim 14, wherein the operations further comprise:
obtaining recipe content associated with the cooking recipe, wherein the recipe content comprises at least one of image data, video data, or text data associated with the cooking recipe; and
generating a unified representation of the recipe content.

18. The system of claim 17, wherein the operations further comprise:
generating, from the unified representation using an artificial intelligence (AI) model, a structured recipe object comprising an indication of the plurality of ingredients and an amount of each of the plurality of ingredients; and
transforming the plurality of ingredients indicated by the structured recipe object into a set of normalized ingredient representations by performing one or more of:
an ingredient amount conversion operation to convert the amount of each of the plurality of ingredients into a common unit of measure;
an ingredient name resolution operation to resolve identifiers associated with each of the plurality of ingredients with a standard ingredient identifier; or
a unit quantity standardization operation to generate, for each of the plurality of ingredients, a unit quantity expressed in the common unit of measure,
wherein the plurality of candidate product records is retrieved based on the set of normalized ingredient representations.

19. The system of claim 18, wherein transforming the plurality of ingredients further comprises:
determining, for at least one ingredient of the plurality of ingredients, a yield factor corresponding to a preparation loss associated with the at least one ingredient; and
adjusting a quantity associated with the at least one ingredient based on the yield factor.

20. A non-transitory computer readable medium comprising instructions that, when executed by a set of one or more processing devices, cause the set of one or more processing devices to perform operations comprising:
obtaining, by a computing system, data associated with a plurality of ingredients of a cooking recipe;
retrieving, from one or more external systems, a plurality of candidate product records, wherein each candidate product record of the plurality of candidate product records corresponds to a product available from the one or more external systems and specifies (i) a unit quantity of a respective ingredient of the plurality of ingredients provided by a unit of the product, and (ii) at least one attribute associated with the product;
identifying, among the plurality of candidate product records, one or more candidate product records based on the at least one attribute and one or more constraints including: (i) a quantity constraint in which unit quantities specified by the one or more candidate product records satisfy a quantity associated with the plurality of ingredients, and (ii) a unit-based constraint corresponding to fixed unit quantities of the products;
generating a machine-readable data structure identifying the one or more candidate product records; and
causing the machine-readable data structure to be stored and made accessible to at least one client device.
